(19) United States
(12) Patent Application Publication
(10) Pub. No.: US 2024/0278200 A1
(43) Pub. Date: Aug. 22, 2024

(54) CONTINUOUSLY OPERATED TEXTURIZING APPARATUS

(71) Applicant: PLANT MEAT MAKERS B.V., AMERSFOORT (NL)

(72) Inventors: Ernst Jan BREEL, Amersfoort (NL); Birgit Laura DEKKERS, Amersfoort (NL)

(21) Appl. No.: 18/291,273

(22) PCT Filed: Jul. 26, 2022
(86) PCT No.: PCT/EP2022/070927

§ 371 Date: Jan. 23, 2024

(30) Foreign Application Priority Data
Jul. 26, 2021 (NL) 2028837

(51) Int. Cl. B01F 27/74; A23J 3/22; A23P 30/00; B01F 27/50; B01F 35/90

(52) U.S. Cl. CPC B01F 27/74; A23J 3/227; A23P 30/00; B01F 27/50; B01F 35/90; B01F 2035/98; B01F 2035/99

(57) ABSTRACT

The present invention relates to a texturizing apparatus, configured to texturize a mass of viscoelastic foodstuff material, the apparatus comprising: —an outer member, which defines an interior, extending along a longitudinal axis between a first end and a second end, —an inner member, which is arranged inside the interior, extending parallel to the longitudinal axis between the first end and the second end. The outer member has an inner surface in the interior that faces an outer surface of the inner member to define a through annular texturizing chamber in between the inner member and the outer member, extending between the first end and the second end. The outer member and the inner member are configured to rotate with respect to each other about the longitudinal axis to subject the foodstuff material in the texturizing chamber to a simple shear flow. The invention is characterized in that the texturizing chamber comprises an upstream chamber segment and a downstream chamber segment, and in that the texturizing apparatus further comprises cooling device, provided at the downstream chamber segment of the texturizing chamber and configured to only cool the downstream chamber segment of the texturizing chamber.

### FIELD OF THE INVENTION

The present invention relates to a texturizing apparatus, configured to texturize a mass of viscoelastic foodstuff material. The present invention further relates to a food production device and to a method of texturizing a mass of viscoelastic foodstuff material.

### STATE OF THE ART

In an aim to provide plant-based meat substitutes that accurately mimic animal-derived meat products, in particular whole cut meat products, it was found necessary to provide texture to a mass of plant based viscoelastic foodstuff material, to mimic the fibrous texture of meat.

A first example of how this texturizing may be carried out, is by means of an extrusion process, of which an example is disclosed in PCT-application WO 2017/012625 A1. During extrusion, the foodstuff material is forced through an enclosed chamber by a screw, being urged in a longitudinal direction. The screw of the extruder is configured to effect turbulent mixing of the foodstuff material. The extruder comprises multiple chamber sections with corresponding discrete screw sections, to be able to subject the foodstuff material to different extrusion parameters over the length of the extruder, in order to obtain the desired properties of the foodstuff material. At a downstream head end of the extruder, a discharge opening is provided, through which the mixed foodstuff material emerges from the extruder. This emersion causes alignment of the foodstuff material, since the foodstuff material is pressed through the discharge opening in a single direction, parallel to the longitudinal direction.

A second example of a texturizing apparatus is disclosed in PCT/EP2021/050026, which does not rely on turbulent mixing of the foodstuff material. Instead, this texturizing apparatus is configured to subject the foodstuff material to a simple shear flow, i.e. a Couette flow, in an annular texturizing chamber between two cylinders. In this type of texturizing apparatuses, it is not desired to have turbulent mixing, like in the above-mentioned extruders. Instead, the simple shear flow mainly consists of a laminar flow, to obtain the alignment in the texturizing chamber already, instead of at the discharging.

Thirdly, it is known to crystallize fatty materials by means of applying shear. However, fatty materials have different properties than viscoelastic materials. In fact, fatty materials are not elastic, but rather tend to flow easily when subjected to a pressure difference. It is therefore not possible to provide texture in said fatty materials, since the material is not able to be maintained in a texturized state.

Despite the fact that the texturizing by means of a laminar simple shear flow, as in the second example above, may result in plant-based meat substitute products that more accurately mimic whole cut meat products, the productivity is relatively low. This is caused by the fact that the texturizing takes place batchwise in a single apparatus, i.e. having a single cell. The process thereby consists of filling the cell, texturizing while heating the foodstuff material, cooling the texturized foodstuff material and discharging the texturized foodstuff material from the cell.

### OBJECT OF THE INVENTION

In view of the above, it is an object of the present invention to provide a texturizing apparatus for texturizing foodstuff materials by means of a simple shear flow at a higher productivity, or at least to provide an alternative texturizing apparatus for texturizing foodstuff materials.

### DETAILED DESCRIPTION

The present invention provides a texturizing apparatus, configured to texturize a mass of viscoelastic foodstuff material, such as a biopolymer mixture for meat substitutes, the apparatus comprising:
an outer member, which defines an interior, extending along a longitudinal axis between a first end and a second end and having a circular cross-section in a plane perpendicular to the longitudinal axis,
an inner member, which is arranged inside the interior, extending parallel to the longitudinal axis between the first end and the second end and having a circular cross-section in a plane perpendicular to the longitudinal axis,
wherein the outer member has an inner surface in the interior that faces an outer surface of the inner member to define a through annular texturizing chamber in between the inner member and the outer member, extending between the first end and the second end, and wherein the outer member and the inner member are configured to rotate with respect to each other about the longitudinal axis to subject the foodstuff material in the texturizing chamber to a simple shear flow,
characterized in that,
a shear gap of the texturizing chamber is defined as the radial spacing between the inner member and the outer member, wherein the shear gap is in the range between 5 mm, especially 10 mm and 50 mm,
in that the texturizing chamber comprises an upstream chamber segment and a downstream chamber segment, and
in that the texturizing apparatus further comprises:
a cooling device, provided at the downstream chamber segment of the texturizing chamber and configured to only cool the downstream chamber segment of the texturizing chamber.

According to the present invention, the texturizing apparatus comprises the outer member and the inner member, which may be provided concentrically, so that the longitudinal axis of the outer member coincides with the longitudinal axis of the inner member. The foodstuff material that is texturized in the texturizing apparatus is a viscoelastic material that may have a dry matter content of more than 20%. An example of such a foodstuff material is a biopolymer mixture for meat substitutes. Prior to the texturizing, these foodstuff materials may have a paste-like or dough-like appearance. During the texturizing, fibrous texture is introduced into the foodstuff material and the resulting end product may be a solid.

Viscoelastic materials have a relatively large viscosity, compared to liquid materials, which may prevent these viscoelastic materials from flowing freely through the present texturizing apparatus. As a result of its viscosity, the pressure difference can be present over the viscoelastic foodstuff material over the length of the apparatus. Hence, the foodstuff material may be subject to a relatively high pressure level in the upstream chamber segment, i.e. at a relatively high temperature, and to a relatively low pressure level in the downstream chamber segment, i.e. after being cooled to a relatively low temperature.

The inner member is located in the interior that is defined by the outer member, so that at least part of an inner surface of the outer member faces at least part of an outer surface of the inner member in a radial direction relative to the longitudinal axis. In particular, the inner member may extend through the entire outer member, so that the entire inner surface of the outer member faces the inner member and that the texturizing chamber in between them extends through the entire outer member.

The outer member may have a cylindrical shape, i.e. having a constant diameter over its length along the longitudinal axis, or may have a conical shape, i.e. having a diameter that changes over its length, for example gradually tapering inward or outward. Similarly, the inner member may have a cylindrical shape, i.e. having a constant diameter over its length along the longitudinal axis, or may have a conical shape, i.e. having a diameter that changes over its length, for example gradually tapering inward or outward.

As a result of the cylindrical or conical shapes, a shear gap of the texturizing chamber, i.e. defined as the radial spacing between the inner member and the outer member, may be constant or may vary over the length along the longitudinal axis. The shear gap may be in the range between 5 mm and 50 mm, for example in the range between 10 mm and 50 mm, preferably having a constant value in this range over its entire length along the longitudinal axis. In case one of the inner member or the outer member has a cylindrical shape and the other one has a conical shape, the width of the shear gap may vary over the length along the longitudinal axis, for example varying in the range between 50 mm to 10 mm.

The outer diameter of the inner member may be in the range between 100 mm and 1200 mm. The texturizing apparatus may thereby have a ratio between the outer diameter of the inner member and the shear gap that is in the range between 0.5 and 0.004, preferably in the range between 0.10 and 0.02, more preferable in the range between 0.05 and 0.04.

Accordingly, the inner diameter of the outer member may be in the range between 110 mm and 1300 mm, so that the resulting shear gap in between inner member and the outer member, i.e. at both side of the inner member, seen with respect to the diameter, is in the above-mentioned range of 10 mm to 50 mm. For example, the outer diameter of the inner member may be approximately 600 mm and the inner diameter of the outer member may be approximately 660 mm, to obtain a shear gap that is about 30 mm wide.

The texturizing apparatus according to the present invention is configured to continuously texturize the mass of foodstuff material, which means that foodstuff material can be fed into the texturizing apparatus continuously, for example at a constant rate. Accordingly, the discharge of texturized foodstuff material may also take place continuously, for example at a constant rate as well.

The texturizing is initiated by a relative rotation between the inner member and the outer member, so that the foodstuff material in the texturizing chamber is subject to an inner surface, i.e. of the outer member, and an outer surface, i.e. of the inner member, that move relative to each in a tangential direction relative to the longitudinal axis. The foodstuff material will become aligned as its contacts the inner surface and the outer surface, because it flows along at least partially with the moving surfaces. This may effect a certain degree of anisotropy in the foodstuff material, which makes the foodstuff material less homogeneous and thereby more analogue to actual whole cut meat products, like beef steak, pork loin or chicken breast.

The velocity profile in the texturizing chamber, e.g. extending over the shear gap, represents a gradient of the velocity of the foodstuff material relative to the inner surface or the outer surface. According to the present invention, the velocity profile is substantially linear to obtain the simple shear flow, i.e. the Couette flow, in the texturizing chamber and to prevent turbulences. The simple shear flow may prevent mixing from occurring in the texturizing chamber, whereas such mixing is essential to take place in the known extruder devices and screw-based heating device. Hence, the mixing in those publications was essential to obtain turbulences and to increase the efficiency of the heating. According to the present invention, it is instead beneficial to avoid mixing and to increase the anisotropy to more accurately mimic actual whole cut meat products.

During texturizing, the foodstuff material travels through the texturizing chamber, i.e. along the longitudinal axis, from the first end of the texturizing chamber to the second end. This axial displacement may be effected by a transportation device, which may be formed by a geometry of the inner member or the outer member, but may alternatively be configured to displace the foodstuff material by a pressure difference over the texturizing chamber between the first end and the second end. During use of the texturizing apparatus, a pressure drop will be present over the length of the apparatus, i.e. between the inlet and the outlet, as a result of the viscoelastic foodstuff material that tends to add resistance against flowing under influence of the pressure difference.

It is important in the texturizing apparatus according to the present invention that the tangential velocity, i.e. as a result of the rotation between the inner member and the outer member, must be relatively large compared to the axial displacement of the foodstuff material. This is required to ensure sufficient texturizing of the foodstuff material and to safeguard that the flow of the foodstuff material remains substantially laminar, i.e. substantially preventing it from becoming turbulent, enabling that substantially only simple shear flow or Couette flow takes place.

The ratio between the tangential velocity and the axial displacement of the foodstuff material may be in the range between 2:1 and 400:1. For example, in a texturizing apparatus having an inner member with an outer diameter of 600 mm, a rotational velocity of 15 rpm may amount to a tangential velocity of approximately 0.50 m/s. To obtain the desired properties, an axial displacement, i.e. an axial velocity along the longitudinal axis, of 0.005 m/s may be set to hold the foodstuff material in the texturing chamber for a sufficient time. This may result in a ratio between the tangential velocity and the axial displacement of about 100:1.

During texturizing or prior to texturizing, the foodstuff material may be heated. To be able to discharge the foodstuff material from the texturizing apparatus, the foodstuff material must be cooled, since otherwise the texture therein would change once it is discharged from the texturizing chamber, which resulting texture would be minor compared to the fibrous texture in actual whole cut meat products. Hence, the viscosity of the foodstuff material may decrease significantly upon heating.

The prior art relied on passive cooling in the texturizing chamber after the heating and the texturizing had taken place. Alternatively, a cooling fluid was passed through the channels of the heating device, to be able to actively cool the foodstuff material after the heating has taken place.

Due to the continuous nature of the operation of the present texturizing device, it is not possible to alternatingly heat and cool the texturizing chamber, as that would result in insufficient heating and/or cooling and thus in non-continuous operation.

As a solution, the texturizing chamber of the texturizing apparatus according to the present invention thereto comprises an upstream chamber segment and a downstream chamber segment. The texturizing chamber is thus subdivided in an upstream chamber segment, which is located at the first end, and a downstream chamber segment, which is located at the second end.

The upstream chamber segment and the downstream chamber segment may be distinct chambers of the texturizing apparatus, for example being separated from each other by a transit passage, allowing flow of foodstuff material from the upstream chamber into the downstream chamber. Alternatively, the upstream chamber segment and the downstream chamber segment may be different parts of a single texturizing chamber, without being physically separated from each other.

The upstream chamber segment and the downstream chamber segment may abut each other directly at a discrete transition section, e.g. a transition point. Alternatively, the texturizing chamber may comprise an intermediate chamber segment in between the upstream chamber segment and the downstream chamber segment.

According to the present invention, the texturizing apparatus further comprises a cooling device, provided at the downstream chamber segment of the texturizing chamber and configured to only cool the downstream chamber segment of the texturizing chamber. As a result thereof, the cooling of the foodstuff material only takes place in the downstream chamber segment, whereas no active cooling is configured to take place in the upstream chamber segment and in the intermediate chamber segment, if present. Hence, the upstream chamber segment may be free of any cooling device.

The foodstuff material is configured to be fed into the upstream chamber segment of the texturizing chamber. The texturizing apparatus is configured to shear the foodstuff material in the upstream chamber segment, to provide fibrous texture to the foodstuff material, upon relative rotation between the inner member and the outer member. The foodstuff material may be heated in the upstream chamber segment or may, alternatively, be preheated, prior to introduction into the upstream chamber segment.

The heated and texturized foodstuff material may enter the downstream chamber segment, optionally via the intermediate chamber segment in which further shearing may take place without heating. The foodstuff material thereby passes through the downstream chamber segment in order to be cooled. In the downstream chamber segment, further texturizing may be exerted onto the foodstuff material while it is being cooled. After having passed the downstream chamber segment, the foodstuff material has been cooled and the foodstuff material can be discharged from the texturizing chamber at a temperature that is low enough to prevent the texture in the foodstuff material from changing, because the viscosity has increased upon cooling.

If an intermediate chamber segment is provided in between the upstream chamber segment and the downstream chamber segment, this section may be free of a heating device and a cooling device. Accordingly, the intermediate chamber segment may only be configured to shear the foodstuff material or may be configured to allow relaxation of the foodstuff material, i.e. not shearing the foodstuff material, prior to cooling in the downstream chamber segment.

A benefit of the present texturizing apparatus is that the obtained texture in the foodstuff material can be improved, compared to the texture that can be provided by means of extrusion. Furthermore, the continuous operation may improve productivity over the existing batchwise texturizing apparatus.

These benefits are enabled by the texturizing chamber comprising multiple sections and the cooling device being configured to only cool the foodstuff material in the downstream chamber segment, so that the texturizing in the upstream chamber segment is not influenced significantly by the cooling in the downstream chamber segment.

The cooling device may be configured to cool the foodstuff material in the downstream chamber segment continuously, for example being configured to cool the foodstuff material at a substantially constant cooling power. The cooling of the foodstuff material by the cooling device in the downstream chamber segment may be effected to cool the foodstuff material to a temperature in the range between 0° C. and 80° C., preferably between 30° C. and 60° C., to allow for discharge from the texturizing chamber.

Alternatively or additionally, the cooling device may be configured to cool the foodstuff material in the downstream chamber segment to a temperature level that is in between 50° C. and 150° C. lower than the temperature of the foodstuff material in the upstream chamber segment.

The texturizing chamber may have a length along the longitudinal axis, e.g. a length of the inner member and of the outer member that is in the range between 1 metre and 10 metres, for example having a length of about 6 metres.

The texturizing apparatus may be configured to rotate the inner member and the outer member with respect to each other at a rotational velocity in the range between 1 and 150 rpm. Alternatively or additionally, the texturizing apparatus may be configured to rotate the inner member and the outer member with respect to each other at a tangential velocity in the range between 0.05 m/s and 5 m/s.

The tangential velocity of 0.05 m/s may be obtained when the texturizing apparatus would comprise an inner member with an outer diameter of 1000 mm that is rotated at 2 rpm and the tangential velocity of 5 m/s may be obtained when the texturizing apparatus would comprise an inner member with an outer diameter of 300 mm that is rotated at 150 rpm.

It was found by the inventors that when the foodstuff material were to be subjected to a rotational velocity in the range of 1-150 rpm or a tangential velocity in the range of 0.05-5 m/s, e.g. for a biopolymer mixture for animal protein substitutes, the corresponding shear rate would cause the texture of the foodstuff material to become as best as possible, namely to accurately mimic that of actual whole cut meat products.

If the foodstuff material were to be subjected to a lower shear rate, the resulting structure in the foodstuff material is only minorly texturized and shows only limited anisotropy. If, on the other hand, the foodstuff material were to be subjected to a higher shear rate, the texture in the resulting foodstuff material would be destroyed due to possible turbulences.

In an embodiment, the texturizing apparatus further comprises a heating device, provided at the upstream chamber segment of the texturizing chamber and configured to only heat the upstream chamber segment of the texturizing chamber.

The heating device is configured to heat the upstream chamber segment of the texturizing chamber to heat, at least during use, the foodstuff material arranged therein. The heating device is provided upstream relative to the cooling device, so that it can heat the foodstuff material without substantially influencing the cooling carried out by the cooling device in the downstream chamber segment.

The heating device is configured to increase the temperature of the upstream chamber segment to a level that is above the ambient temperature, in order to subject the foodstuff material to an elevated temperature during use of the apparatus. The heating in the upstream chamber segment may effect a pressurization of the foodstuff material, following the thermal expansion thereof. A pressure difference may thereby occur between the upstream chamber segment and the downstream chamber segment, i.e. where the foodstuff material is cooled. The viscoelastic foodstuff material contributes in maintaining this pressure difference, as it may add resistance against flowing, which would not be the case with the liquid fatty material known from the prior art.

The required elevated temperature differs per type of foodstuff material, but may for example being in between 50° C. and 200° C., preferably between 90° C. and 140° C., for a protein-rich biopolymer mixture. At these temperatures, the pressure in the upstream chamber segment may increase above the ambient pressure under the influence of the heating, for example being caused by evaporation of liquids, such as water, or by changes in the protein structure under elevated temperatures, in the foodstuff material.

At the elevated temperature, the viscosity of the foodstuff material is lowered and the biopolymers are mobilized to effect alignment of the mass. The aligned mass results in a fibrous texture of the foodstuff material, being aligned in the direction of the relative rotation between the inner member and the outer member, e.g. becoming aligned in the tangential direction.

In an embodiment of the texturizing apparatus, the inner member is substantially hollow, defining an inner member interior. The hollow inner member interior may be accessible from outside the texturizing apparatus or may, alternatively, be closed-off substantially from the environment of the texturizing apparatus.

In particular, the hollow inner member may have an outer diameter that is relatively large compared to the shear gap, for example having an outer diameter that is at least two times larger than the shear gap. For example, the outer diameter of the inner member may have a diameter of about 200 mm to 300 mm, whereas the shear gap may have a width in between 20 mm and 30 mm, so that the outer diameter of the inner member may be about 10 times larger than the shear gap.

This may provide a further difference of the present texturizing apparatus with respect to extruder apparatuses, because the ratio between the outer diameter of an axle of an extruder screw and the blade width of the screw is much smaller. As a result, such axles of extruder screws could generally not be provided hollow, since that would result in a too low torsional strength and stiffness that would cause the screw to fail during use.

In the texturizing apparatus according to the present embodiment, with the outer diameter of the hollow inner member being relatively large compared to the shear gap, the torsional stiffness of the inner member is less critical. This allows the inner member to be provided hollow, whilst still providing for sufficient torsional strength and stiffness.

In an embodiment of the texturizing apparatus, the hollow inner member is configured to store a buffer volume of the heating fluid during use, for example configured to hold a volume of steam inside. The texturizing apparatus is thereby configured to obtain steam from the hollow inner member into the heating fluid circuit, to transfer heat from the steam towards the viscoelastic foodstuff material, to effect heating thereof.

In an embodiment of the texturizing apparatus, the outer member comprises:
a first outer wall section, extending between the first end and a transition section, located in between the first end and the second end, and
a second outer wall section, extending between the transition section and the second end,
wherein the upstream chamber segment is defined between the first outer wall section and the inner member, and wherein the downstream chamber segment is defined between the second outer wall section and the inner member.

According to this embodiment, the outer member is subdivided in a first outer wall section and a second outer wall section, located downstream of the first outer wall section. The first outer wall section extends from the first end towards the transition section, facing an upstream part of the inner member, and the second outer wall section extends from the transition section towards the second end, facing a downstream part of the inner member.

At the transition section, a direct contact may be formed between the first outer wall section and the second outer wall section, for example being a discrete transition point between both outer wall sections.

The first outer wall section may have a first length along the longitudinal axis and the second outer wall section may have a second length along the longitudinal axis. The first length may be equal to the second length, so that the length of the upstream chamber segment along the longitudinal axis is equal to the length of the downstream chamber segment. Alternatively, the first length may be larger than the second length, or vice versa.

The amount of cooling of the foodstuff material by the cooling device in the downstream chamber segment and, if present, the amount of heating of the foodstuff material by the heating device in the upstream chamber segment may be dependent on the second length and the first length, respectively. Accordingly, the second length and the first length may be varied to adjust the amount of cooling and heating, i.e. for a certain fixed cooling power of the cooling device and fixed heating power of the heating device.

As an alternative to the discrete transition point between the first outer wall section and the second outer wall section, the outer wall may comprise an intermediate outer wall section, located in between the first outer wall section and the second outer wall section. The texturizing chamber may thereby comprise the intermediate chamber segment, located in between the upstream chamber segment and the downstream chamber segment. The intermediate chamber segment is thereby defined in between the intermediate outer wall section and the inner member, in particular an intermediate part of the inner member.

The intermediate chamber segment may be free of heating devices and cooling devices, so that the temperature of the foodstuff material may be relatively constant as it passes through the intermediate chamber segment. It is envisaged that passive cooling of the foodstuff material, i.e. from the intermediate chamber segment of the texturizing chamber to the ambient, may be unavoidable within the context of this embodiment.

In the intermediate chamber segment, the inner diameter of the outer member may vary, to alter the cross-sectional area. This change in diameter may effect a decrease in the pressure level of the foodstuff material, so that the pressure level in the downstream chamber segment may be lower than the pressure level in the upstream chamber segment.

As a further alternative to the discrete transition point between the first outer wall section and the second outer wall section, the upstream chamber section and the downstream chamber may be interconnected via a transit passage that is free of an inner member. The transit passage may, for example, be embodied as a hose or pipe through which the foodstuff material is displaced under influence of a difference in pressure level over it. The transit passage is preferably heat-insulating, to prevent the foodstuff material in the downstream chamber segment to be heated by heat from the upstream chamber segment and to prevent the foodstuff material in the upstream chamber segment to be cooled from downstream chamber segment

In a further embodiment of the texturizing apparatus, the first outer wall section has a first inner diameter and the second outer wall section has a second inner diameter, different from the first inner diameter. The inner diameter of the outer member may be different between both wall sections and, accordingly, the shear gap may be different between the upstream chamber segment and the downstream chamber segment.

In a further embodiment of the texturizing apparatus, the first outer wall section or the second outer wall section may be subdivided in two or more different parts, for example each having a different inner diameter. The first inner wall section or the second inner wall section may thereby have constant respective outer diameters.

For example, the first outer wall section may, seen along the longitudinal axis from the first end, first have a part with a relatively large inner diameter and then have a second part with a relatively small diameter. Accordingly, the shear gap in the upstream chamber segment can be relatively wide at the first part of the first outer wall section and relatively wide at the second part of the first outer wall section.

Alternatively or additionally, the second outer wall section may, seen along the longitudinal axis towards the second end, first have a part with a relatively small inner diameter and then have a second part with a relatively large inner diameter. Accordingly, the shear gap in the downstream chamber segment can be relatively narrow at the first part of the second outer wall section and relatively wide at the second part of the second outer wall section.

At the first part of the second outer wall section, the foodstuff material may be in contact with the outer member, i.e. in order to be cooled by the cooling device. Once the foodstuff material arrives at the second part, it can come loose from the outer member, thereby facilitating removal of the foodstuff material out of the texturizing chamber. Furthermore, the risk of tearing the cooled foodstuff material, following the reduced viscosity upon cooling, is reduced by the lack of contact with the outer member.

Furthermore, the cooling device may be omitted at the second part of the second outer wall section.

In a further embodiment, the parts of the outer wall sections, e.g. the first outer wall section, the second outer wall section and the intermediate outer wall section, may be distinct modules that are attached to each other to form, in combination, the outer member. Each of the modules forming the second outer wall section may comprise a distinct cooling device, so that the different modules of the second outer wall section may be cooled to different temperatures. Similarly, each of the modules forming the first outer wall section may comprise a distinct heating device, so that the different modules of the first outer wall section may be heated to different temperatures.

Alternatively or additionally, each of the modules forming the first outer wall section may have a different inner diameter, so that the shear gap defined between the inner member and the first outer wall section may change over the length of the upstream chamber segment. Similarly, each of the modules forming the second outer wall section may have a different inner diameter, so that the shear gap defined between the inner member and the second outer wall section may change over the length of the downstream chamber segment.

By varying the number of modules, the overall length of the texturizing chamber can be changed accordingly. This implies that the residence time of the foodstuff material in the texturizing chamber can be changed independently of the tangential velocity and axial displacement velocity of the foodstuff material. As a result, the shear rate and other shearing properties of the foodstuff material are not influenced, which may be useful when a single texturizing apparatus were to be used for different foodstuff materials, e.g. having different ingredients and requiring different heating and cooling profiles.

If it is, for example, required to heat the foodstuff material for a longer period of time, more modules can be provided to form the upstream chamber section, so that the length of the upstream chamber section, and thus the residence time in the heated upstream chamber section can be increased.

If it is, on the other hand, to increase the relaxation time of the foodstuff material, more modules can be provided to form the intermediate chamber section, so that the length of the intermediate chamber section, can be increased.

In an additional or alternative embodiment of the texturizing apparatus, the inner member comprises:
a first inner wall section, facing the first outer wall section to define the upstream chamber segment, and
a second inner wall section, facing the second outer wall section to define the downstream chamber segment.

The inner member may have a discrete transition between the first inner wall section and the second inner wall section.

The first inner wall section may have a length along the longitudinal axis equal to the first length, i.e. equal to the length of the first outer wall section. Accordingly, the second inner wall section may have a length along the longitudinal axis equal to the second length, i.e. equal to the length of the second outer wall section.

As an alternative to the discrete transition point between the first inner wall section and the second inner wall section, the inner wall may comprise an intermediate inner wall section, located in between the first inner wall section and the second inner wall section. The intermediate inner wall section thereby defines the intermediate chamber segment of the texturizing chamber against the outer member, e.g. against the intermediate outer wall section.

In the intermediate chamber segment, the outer diameter of the inner member may vary, to alter the cross-sectional area. This change in diameter may effect a decrease in the pressure level of the foodstuff material, so that the pressure level in the downstream chamber segment may be lower than the pressure level in the upstream chamber segment.

In a further embodiment of the texturizing apparatus, the first inner wall section has a first outer diameter and the second inner wall section has a second outer diameter, different from the first outer diameter. The outer diameter of the inner member may be different between both wall sections and, accordingly, the shear gap may be different between the upstream chamber segment and the downstream chamber segment.

In a further embodiment of the texturizing apparatus, the first inner wall section or the second inner wall section may be subdivided in two or more different parts, for example each having a different outer diameter. The first outer wall section or the second outer wall section may thereby have constant respective outer diameters.

In a further embodiment, the parts of the inner wall sections may be distinct modules that are attached to each other to form, in combination, the first inner wall section or the second inner wall section. These modular inner wall sections may be combined with the modular outer wall sections disclosed herein.

Each of the modules forming the first inner wall section may have a different outer diameter, so that the shear gap defined between the outer member and the first inner wall section may change over the length of the upstream chamber segment. Similarly, each of the modules forming the second inner wall section may have a different outer diameter, so that the shear gap defined between the outer member and the second inner wall section may change over the length of the downstream chamber segment.

By varying the number of modules, the overall length of the texturizing chamber can be changed accordingly. This implies that the residence time of the foodstuff material in the texturizing chamber can be changed independently of the tangential velocity and axial displacement velocity of the foodstuff material. As a result, the shear rate and other shearing properties of the foodstuff material are not influenced, which may be useful when a single texturizing apparatus were to be used for different foodstuff materials, e.g. having different ingredients and requiring different heating and cooling profiles.

If it is, for example, required to cool the foodstuff material for a longer period of time, more modules can be provided to form the downstream chamber section, so that the length of the downstream chamber section, and thus the residence time in the cooled downstream chamber section can be increased.

In an additional or alternative embodiment of the texturizing apparatus, the inner member comprises a separation wall in between the first inner wall section and the second inner wall section, aligned substantially perpendicular to the longitudinal axis and configured to subdivide the inner member interior in a first inner member interior and a second inner member interior.

The separation wall inwardly projects into the inner member interior, i.e. extending in a plane spanned of radial inward directions relative to the longitudinal axis. The separation wall may be provided at the transition section, e.g. the discrete transition portion, between the first inner wall section and the second inner wall section, or at the intermediate inner wall section.

The separation wall is configured to separate the first inner member interior, i.e. where the heating device for heating the upstream chamber may be located, from the second inner member interior, i.e. where the cooling device for cooling the downstream chamber may be located. As such, the separation wall may form a thermal insulation between the first inner member interior and the second inner member interior to prevent the heating in the first interior section from influencing the cooling in the second interior section, or vice versa.

In particular, the separation wall may delimit an upstream interior part of the inner member, which may be configured to receive a heating fluid, for example steam, to heat the foodstuff material in the upstream chamber section.

Furthermore, the separation wall may have a structural benefit, since it may reinforce the circumferential wall of the inner member. The separation wall may prevent buckling of the inner member upon rotation and may increase the torsional strength of the inner member.

In an embodiment of the texturizing chamber, the heating device is provided in the first outer wall section and/or in the first inner wall section, and/or the cooling device is provided in the second outer wall section and/or in the second inner wall section.

The heating of the foodstuff material in the upstream chamber segment may thereby be initiated from the wall of the outer member, from the wall of the inner member or from a combination of both. The heating device may surround the respective wall section, for example being embodied as a heating jacket. Preferably, however, the heating device is integrated in the first outer wall section and/or in the first inner wall section to heat the foodstuff material directly from the respective wall section.

Similarly, the cooling of the foodstuff material in the downstream chamber segment may thereby be initiated from the wall of the outer member, from the wall of the inner member or from a combination of both. The cooling device may surround the respective wall section, for example being embodied as a cooling jacket. Preferably, however, the cooling device is integrated in the second outer wall section and/or in the second inner wall section to cool the foodstuff material directly from the respective wall section.

In a further embodiment of the texturizing apparatus, the heating device comprises a heating fluid circuit that extends through the first outer wall section and/or through the first inner wall section, configured to guide a flow of heating fluid.

The first outer wall section and/or the first inner wall section may be a hollow wall section to define the heating fluid circuit, so that heat from the heating fluid in the heating fluid circuit can be conducted to the respective wall section. From the wall section, the heat can, in turn, be transferred onto the foodstuff material that is in contact with that wall section.

The heating fluid circuit is preferably located in the stationary one of the inner member and the outer member, for example being located in the stationary outer member, so that the inner member can be freely driven in rotation. Alternatively, however, the heating fluid circuit may be provided in the rotary one of the inner member and the outer member, wherein the heating fluid circuit may comprise a rotary joint to allow the heating fluid to flow into the rotary member.

The heating fluid circuit may be arranged in between the texturizing chamber and the surroundings of the texturizing apparatus, for example being arranged in the outer wall section exposed to the surroundings or in the inner wall section, should the inner member be hollow. This may ensure that the heating device forms a thermal buffer between the surroundings and the viscoelastic foodstuff material during use of the apparatus. This may improve the controlling of the temperature of the foodstuff material, since thermal influences from the surroundings onto the foodstuff material are blocked by the heating fluid circuit.

Preferably, a flow direction of the heating fluid in the heating fluid circuit is in a direction opposite to the axial displacement of the foodstuff material in the upstream chamber segment, i.e. the heating fluid flow direction being aligned from the transition section towards the first end. In this way, the exchange of heat from the heating fluid to the foodstuff material may be a counter-current exchange of heat, to obtain a higher efficiency than when the heating fluid and the foodstuff material were to move in the same direction.

The heating fluid in the heating fluid circuit may be spread over the entire circumferential surface of the inner member and/or the outer member, to increase the surface area at which exchange of heat can take place from the heating fluid to the foodstuff material.

The heating device may further comprise a heat exchanger device, located remote from the texturizing chamber and in fluid connection with the heating fluid circuit to allow transport of the heating fluid between the heating fluid circuit and the heat exchanger device. The heat exchanger device may be configured to heat the heating fluid remote from the texturizing chamber and to pump the heated heating fluid towards the heating fluid circuit in the first outer wall section and/or the first inner wall section, where the heat is transferred onto the foodstuff material in the upstream chamber segment. The heating fluid is thereby cooled and is transported back to the heat exchanger device, which is configured to re-heat the heating fluid.

The heating fluid may be pressurized steam, having a temperature of more than 100° C., i.e. on entry in the heating fluid circuit. The use of steam may be beneficial for heating the foodstuff material, as it may undergo a phase change when being cooled. Cooling the steam from a vapor phase to a liquid phase may release the heat of condensation from the steam, which may be contribute in heating the foodstuff material.

Alternatively, the heating device may be an electric heating device, such as an inductive heating device, a resistance heating device or an infrared heating device. These electric heating device may be configured to directly heat the foodstuff material, since they not need to reply on a heating fluid, allowing the apparatus to be constructed less complex.

In an alternative or additional embodiment of the texturizing apparatus, the cooling device comprises a cooling fluid circuit that extends through the second outer wall section and/or through the second inner wall section, configured to guide a flow of cooling fluid.

The second outer wall section and/or the second inner wall section may be a hollow wall section to define the cooling fluid circuit, so that heat from the foodstuff material in the downstream chamber segment can be withdrawn into the cooling fluid in the cooling fluid circuit, e.g. via the respective wall section with which the foodstuff material is in contact.

The cooling fluid circuit is preferably located in the stationary one of the inner member and the outer member as well, for example being located in the stationary outer member, so that the inner member can be freely driven in rotation. Alternatively, however, the cooling fluid circuit may be provided in the rotary one of the inner member and the outer member, wherein the cooling fluid circuit may comprise a rotary joint to allow the cooling fluid to flow into the rotary member.

The cooling fluid circuit may be arranged in between the texturizing chamber and the surroundings of the texturizing apparatus, for example being arranged in the outer wall section exposed to the surroundings or in the inner wall section, should the inner member be hollow. This may ensure that the cooling device forms a thermal buffer between the surroundings and the viscoelastic foodstuff material during use of the apparatus. This may improve the controlling of the temperature of the foodstuff material, since thermal influences from the surroundings onto the foodstuff material are blocked by the cooling fluid circuit. Furthermore, it may provide the benefit that the foodstuff material can be cooled actively with the cooling fluid, whereas existing apparatuses relied on passive cooling under influence of cold air in the ambient of the apparatus.

Preferably, a flow direction of the cooling fluid in the cooling fluid circuit is in a direction opposite to the axial displacement of the foodstuff material in the downstream chamber segment, i.e. the cooling fluid flow direction being aligned from the second end towards the transition section. In this way, the exchange of heat from the foodstuff material to the cooling fluid may be a counter-current exchange of heat, to obtain a higher efficiency than when the cooling fluid and the foodstuff material were to move in the same direction.

The cooling fluid in the cooling fluid circuit may be spread over the entire circumferential surface of the inner member and/or the outer member, to increase the surface area at which exchange of heat can take place from the foodstuff material to the cooling fluid.

The cooling device may further comprise a second heat exchanger device, located remote from the texturizing chamber and in fluid connection with the cooling fluid circuit to allow transport of the cooling fluid between the cooling fluid circuit and the second heat exchanger device. The second heat exchanger device may be configured to cool the cooling fluid remote from the texturizing chamber and to pump the cooled cooling fluid towards the cooling fluid circuit in the second outer wall section and/or the second inner wall section, where heat is withdrawn from the foodstuff material in the downstream chamber segment into the cooling fluid in the cooling fluid circuit. The cooling fluid is thereby heated and is transported back to the second heat exchanger device, which is configured to cool the cooling fluid again.

In an embodiment, the cooling fluid may be liquid, having a temperature of more than 0° C. It was found by the applicant that water cooling can be beneficial, due to the relatively low temperature and low risk of contamination of the foodstuff material in case of leakage.

In an embodiment, the texturizing apparatus further comprises:
an entrance opening, located at the first end, in direct fluid contact with the upstream chamber segment and configured to provide access to the texturizing chamber for the mass of foodstuff material, and
a discharge port, located at the second end, for example at a position radial to the longitudinal axis, in direct fluid contact with the downstream chamber segment and configured to allow discharge of texturized foodstuff material from the texturizing chamber.

The entrance opening and the discharge port are located at opposite ends of the texturizing chamber, seen along the longitudinal axis. The foodstuff material thereby passes through substantially the entire texturizing chamber on its path from the entrance opening to the discharge port, i.e. undergoing its axial displacement through the texturizing chamber.

The discharge port may be positioned radially relative to the axial direction, which means that the foodstuff material is configured to be discharged in a discharge direction having a least a component in the radial direction, for example in a discharge direction aligned in between the radial direction and the tangential direction.

Alternatively, however, the discharge port may be positioned axially at the downstream head end of the texturizing chamber. Such an axial discharge port may offer the benefit that the foodstuff material can be discharged from the texturizing chamber in a direction substantially parallel to the longitudinal direction, i.e., parallel to the direction along which the foodstuff material is transported through the texturizing chamber.

This radial discharge port provides a further difference over existing extruders, i.e. in which axial discharge of the foodstuff material was essential to obtain the fibrous texture. By discharging the foodstuff material radially, it can be scraped from the inner member upon rotation of the inner member. As such, a continuous, i.e. tangential slab of foodstuff material can be discharged, so that the tangential fibrous texture is not disturbed and that the discharged products can be as large as possible.

In an embodiment of the texturizing apparatus, the outer member is configured to be held stationary, and the inner member is configured to be rotated, i.e. with respect to the outer member.

According to this embodiment, the outer member is held stationary, for example in a frame assembly of the texturizing apparatus. The texturizing apparatus may further comprise a motor, such as an electric motor, which may be mounted on the frame assembly and which is configured to rotate the inner member.

The stationary outer member may be beneficial in case the heating device, i.e. the heating fluid circuit, and/or cooling device, i.e. the cooling fluid circuit, were to be included in the outer member. In this way, all fluid connections can be held stationary as well, reducing complexity of the apparatus. Furthermore, the inner surface of the outer member has a larger surface area than the outer surface of the inner member, as a result of the gap between the inner member and the outer member. This may provide a further benefit that the heat-conductive area can be larger when the heating device and/or the cooling device were to be provided in the outer member, thus offering an improved heat exchange.

In a further embodiment, the texturizing apparatus comprises a transportation device, configured to transport the foodstuff material through the texturizing chamber, i.e. to axially displace the foodstuff material in a direction parallel to the longitudinal axis.

During texturizing, the foodstuff material travels through the texturizing chamber, i.e. along the longitudinal axis, from the first end of the texturizing chamber to the second end. This axial displacement may be effected by the transportation device, which may be formed by a geometry of the inner member or the outer member. Alternatively, the transportation device may be configured to displace the foodstuff material by a pressure difference over the texturizing chamber between the first end and the second end.

It is important in the texturizing apparatus according to the present invention that the tangential velocity, i.e. as a result of the rotation between the inner member and the outer member, must be relatively large compared to the axial displacement of the foodstuff material. This is required to ensure sufficient texturizing of the foodstuff material and to safeguard that the flow of the foodstuff material remains substantially laminar, preventing it from becoming turbulent, allowing simple shear flow or Couette flow to take place.

In a further embodiment of the texturizing apparatus, the transportation device comprises an auger extending spirally over at least part an outer surface of the inner member, the auger defining an unobstructed spiral path through the texturizing chamber.

According to this embodiment, the outer member may be held stationary and the inner member may be configured to be driven in rotation. Alternatively, where the inner member may be held stationary and the outer member may be configured to be driven in rotation, the auger may extend spirally over at least part an inner surface of the outer member.

The auger may be configured to axially displace the foodstuff material through the texturizing chamber, i.e. along the longitudinal axis, during shearing and upon rotation of the inner member, i.e. with respect to the outer member.

The unobstructed spiral path implies that the foodstuff material may not encounter any ridges or disturbances on the auger as it is displaced through the texturizing chamber. In the known extruder devices, such disturbances are present, but not harmful there, because the augers in extruders serve the purpose of pressurizing, displacing, kneading and mixing the foodstuff material. In the present texturizing apparatuses, such disturbances would be harmful, as they would interrupt the simple shear flow and would therefore negatively influence the texturizing of the foodstuff material.

According to the present embodiment, as a result of the unobstructed spiral path, the foodstuff material may remain in contact with the outer surface of the inner member and/or with the inner surface of the outer member during its entire path through the texturizing chamber.

The auger may comprise a single spiral path, but may alternatively comprise multiple spiral paths, i.e. having respective leads which are angularly spaced over the circumference of the inner member. For example, the auger may comprise two spiral paths of which the leads are spaced 180° about the circumference of the inner member.

As such, the auger may have a relatively low pitch. As a result, it may be achieved that the shearing velocity in the tangential direction is significantly larger, for example 2 to 400 times larger, than the axial displacement for a certain rotational velocity of the auger and the inner member.

The auger may extend over the entire first inner wall section of the inner member, so that it extends through the entire upstream chamber segment. The auger may furthermore extend over a part of the second inner wall section, e.g. facing the first part of the second outer wall section with the relatively small inner diameter and the cooling device, so that it extends only through part of the downstream chamber segment. A second part of the second inner wall section, e.g. facing the second part of the second outer wall section with the relatively large inner diameter, may be free of an auger. As such, the foodstuff material will not come in contact with an auger after it was cooled down by the cooling device, thereby preventing disturbance of the texture that has been created.

In a further embodiment of the texturizing apparatus, the auger has a pitch angle in the range between 0.01° and 5° relative to the tangential direction.

For example, the outer diameter of the inner member may be 300 mm and the displacement of the foodstuff material after a single rotation between the inner member and the outer member may be 100 mm, resulting in a pitch angle of 0.6°. Alternatively, the outer diameter of the inner member may be 1000 mm and the displacement of the foodstuff material after a single rotation may be 30 mm, resulting in a pitch angle of 0.05°.

In an alternative or additional embodiment of the texturizing apparatus, a height of the auger, i.e. in a radial direction relative to the longitudinal axis, substantially corresponds to the spacing between the inner member and the outer member in the radial direction.

According to this embodiment, the auger may span the entire shear gap, so that the auger can act directly on parts of the foodstuff material both located adjacent the inner member and adjacent the outer member.

In an alternative embodiment, the height of the auger, i.e. in a radial direction relative to the longitudinal axis, corresponds to only part of the spacing between the inner member and the outer member in the radial direction, for example to less than 85%, preferably less than 75%, most preferable less than 65% of the radial spacing between the inner member and the outer member. As such, the auger spans only part of the shear gap, so that it only acts directly on parts of the foodstuff material located adjacent the inner member. Other parts of the foodstuff material, i.e. parts of the foodstuff material located away from the inner member, but for example located adjacent the outer member, will only be forced in the axial direction indirectly. This reduces contact between the auger and the foodstuff material may contribute to an improved simple shear flow, especially in parts of the foodstuff material in contact with the outer member.

In an alternative or additional embodiment, the transportation device is configured to axially displace the foodstuff material through the texturizing chamber under influence of a pressure difference, i.e. between the first end and the second end.

The transportation device may thereto be configured to feed the foodstuff material into the texturizing chamber, i.e. into the upstream chamber segment, at a feeding pressure level, which is higher than a pressure level of the ambient of the texturizing apparatus. At the second end of the texturizing chamber, e.g. at the discharge port, the foodstuff material may be subject the pressure level of the ambient. Accordingly, the foodstuff material may be subject to a pressure gradient along the longitudinal axis, which pressure gradient may initiate axial displacement of the foodstuff material. A further pressure gradient over the length of the pressurizing chamber may result from the temperature difference of the foodstuff material between the upstream chamber segment and the downstream chamber segment.

Optionally, the transportation device may comprise a combination of the pressure-driven axial displacement of the foodstuff material and the auger. For example, the transportation device may comprise an auger located in the upstream chamber segment to axially displace the foodstuff material in the upstream chamber segment under influence of the auger, whereas the transportation device may further be configured to displace the foodstuff material under influence of a pressure difference in the downstream chamber segment.

In an embodiment of the texturizing apparatus, the discharge port comprises an adjustable aperture, configured to adjust a cross-sectional area of the discharge port.

By changing the cross-sectional area of the discharge port, the pressure drop over the discharge port can be adjusted. Outside the texturizing apparatus, i.e. downstream of the discharge port, the pressure level is at the ambient pressure level. Upstream of the discharge port, i.e. inside the downstream chamber segment of the texturizing chamber, the pressure level may be varied in dependence of the pressure drop over the discharge port.

The adjustable aperture may be varied stepless in a range between fully closed, in which discharge of foodstuff material from the downstream chamber segment can be fully blocked, and fully opened, in which the pressure drop over the discharge port is as low as possible.

By changing the pressure level inside the texturizing apparatus under influence of the adjustable aperture, shearing parameters of the foodstuff material inside the texturizing chamber may be adjusted to further contribute to obtaining the desired fibrous texture.

The adjustable aperture may comprise a knife, which is configured to cut the foodstuff material that is discharged from the texturizing apparatus. In particular, the knife may be configured to cut the foodstuff material to a certain thickness. Preferably, the position of the knife can be adjusted by the adjustable aperture, so that the thickness of the foodstuff material discharged from the texturizing chamber can be adjusted upon adjustment of the adjustable aperture.

In an additional or alternative embodiment, the texturizing apparatus comprises a transit passage in between the upstream chamber and the downstream chamber. This transit passage may have a cross-sectional area that is relatively small, compared to the cross-sectional area of the upstream chamber segment and/or the downstream chamber segment. As a result of the small cross-section, the transit passage may introduce a throttling effect on the foodstuff material that passes from the upstream chamber to the downstream chamber. The throttling effect may thereby result in a pressure drop taking place over the transit passage, so that the pressure level in the upstream chamber segment is larger than the pressure level in the downstream chamber segment.

In an embodiment, the texturizing apparatus further comprises one or more temperature sensors located in the texturizing chamber and configured to emit a sensor signal representative for the temperature in the texturizing chamber.

The texturizing apparatus may, for example, comprise multiple temperature sensors. Seen along the longitudinal axis, a first one of the temperature sensors may be located at the first end, i.e. adjacent the entrance opening, to measure the temperature of the foodstuff material that is fed into the texturizing chamber, i.e. into the upstream chamber segment.

A second one of the temperature sensors may be located at the end of the upstream chamber segment, e.g. towards the transition section, to measure the temperature of the foodstuff material after heating by the heating device in the upstream chamber segment.

A third one of the temperature sensors may be located in the downstream chamber segment, for example directly downstream of the cooling device, so that the temperature of the foodstuff material can be measured directly after cooling by the cooling device in the downstream chamber segment. In particular, the third temperature sensor may be located at the transition between the first part of the second outer wall section, i.e. with the relatively small inner diameter, and the second part of the second outer wall section, i.e. with the relatively large inner diameter, so that the temperature of the foodstuff material can be measured prior to expansion.

Finally, a fourth one of the temperature sensors may be located at the second end, i.e. adjacent the discharge port, to measure the temperature of the foodstuff material that is discharged from the texturizing chamber, i.e. from the downstream chamber segment.

In an embodiment, the texturizing apparatus further comprises one or more pressure sensors located in the texturizing chamber and configured to emit a pressure signal representative for the pressure level in the texturizing chamber.

The texturizing apparatus may, for example, comprise multiple pressure sensors. Seen along the longitudinal axis, a first one of the pressure sensors may be located at the first end, i.e. adjacent the entrance opening, to measure the pressure level of the foodstuff material that is fed into the texturizing chamber, i.e. into the upstream chamber segment.

A second one of the pressure sensors may be located at the end of the upstream chamber segment, e.g. towards the transition section, to measure the pressure level of the foodstuff material after heating by the heating device in the upstream chamber segment, e.g. to measure an increase in pressure following thermal expansion of the foodstuff material after heating.

A third one of the pressure sensors may be located in the downstream chamber segment, for example directly downstream of the cooling device, so that the pressure level of the foodstuff material can be measured directly after cooling by the cooling device in the downstream chamber segment, e.g. to measure a decrease in pressure following thermal contraction of the foodstuff material after cooling. In particular, the third pressure sensor may be located at the transition between the first part of the second outer wall section, i.e. with the relatively small inner diameter, and the second part of the second outer wall section, i.e. with the relatively large inner diameter, so that the pressure level of the foodstuff material can be measured prior to expansion.

Finally, a fourth one of the pressure sensors may be located at the second end, i.e. adjacent the discharge port, to measure the pressure level of the foodstuff material that is discharged from the texturizing chamber, i.e. from the downstream chamber segment.

In a further embodiment, the texturizing apparatus further comprises a control unit, configured to control the adjustable aperture on the basis of the measured temperature and/or pressure level in the texturizing chamber.

According to this embodiment, the adjustable aperture may be actively controlled by the control unit, so that the pressure level in the texturizing chamber can be changed. This may result in different temperature and/or pressure conditions inside the texturizing chamber, so that these conditions can be optimally adjusted towards the desired conditions. In particular, the control unit may control the adjustable aperture in a feedback-manner, i.e. by repeating steps of measuring with the sensors and of adjusting the adjustable aperture.

In a further embodiment of the texturizing apparatus, the control unit is further configured to control the heating device and/or the cooling device on the basis of the measured temperature in the texturizing chamber.

The controlling of the heating and the cooling may also effect a change in temperature and pressure in the texturizing chamber. These changes can be measured by the temperature sensor and the pressure sensor, so that the control unit can adjust setting values for the heating and the cooling to obtain optimal conditions for obtaining the desired fibrous texture.

In an embodiment of the texturizing apparatus, at least part of the inner surface of the outer member and/or at least part of the outer surface of the inner member comprises a corrugated surface.

The corrugated surface may be configured to increase contact between the respective surface of the inner or outer member and the foodstuff material during use of the apparatus. This increased contact, e.g. increased friction, may in particular take place when the foodstuff material is heated, i.e. having a reduced viscosity. Furthermore, the corrugated surface may, reduce contact with the foodstuff material, compared to a smooth surface, when the foodstuff material were to be cooled, i.e. being solidified and having an increased viscosity.

The corrugated surface for example comprises grooves and/or ridges, which are configured to increase the friction between the foodstuff material and the inner member and/or outer member, compared to when the inner member and/or outer member were to be provided smooth. With an increased friction on the foodstuff material, the shear stress that is applied on the foodstuff material during use of the texturizing apparatus can be increased and slip can be reduced, or possibly be avoided, in order to alter the fibrous texture that is created in the foodstuff material.

The corrugations may extend over the entire surface of the inner member and/or the outer member, for example as lengthwise ridges and grooves that extend parallel to the longitudinal axis and around the entire circumference of the inner member and/or the outer member. As an alternative, the corrugations may only extend over the first inner wall section and/or the first outer wall section, so that the corrugations are only provided in the upstream chamber segment.

The ridges and grooves may alternatively be arranged in a wave-like pattern or the like. Additionally or alternatively, the corrugations may comprise localized protrusions that project into the texturizing chamber, when seen from nominal surfaces of the outer member and/or the inner member. These localized protrusions may be arranged in a certain pattern, being spread across the entire surface of the inner member and/or the outer member.

The corrugated surface may, as a further alternative, form part of the transportation device and comprises helical grooves and ridges, provided on the outer surface of the inner member and/or the inner surface of the outer member. These helical corrugations may be beneficial in the absence of an auger and may be configured to axially displace the foodstuff material through the texturizing chamber, i.e. without pressurizing the foodstuff material significantly. Instead, the axial displacement of the foodstuff material by the transportation device may here be initiated by an axial shear force component aligned parallel to the longitudinal axis under influence of the helical corrugations, thereby further contributing to the desired simple shear flow.

In an embodiment, the texturizing apparatus further comprises a drive, configured to drive the inner member in rotation, i.e. relative to the outer member.

According to this embodiment, the outer member may be held stationary, for example in a frame assembly of the texturizing apparatus. The drive may be embodied as a motor, for example as an electric motor, which may be mounted on the frame assembly and which is configured to rotate the inner member.

In an embodiment, the texturizing apparatus further comprises one or more injectors projecting into the texturizing chamber, configured to inject liquid ingredients and/or water into the foodstuff material in the texturizing chamber.

The injectors are configured to feed the liquid ingredients in the texturizing chamber directly, for example into the upstream chamber segment and/or into the downstream chamber segment. Multiple injectors may be provided along the path of the foodstuff material through the texturizing chamber, in order to feed liquid ingredients to the foodstuff material at certain stages of the shearing process, in particular to feed different types of liquid ingredients, such as water or vegetable oil, to the foodstuff material at different stages of the shearing process.

According to a second aspect, the present invention provides a food production device, configured to form foodstuff products from a mass of viscoelastic foodstuff material, such as a biopolymer mixture for meat substitutes, the food production device comprising,
the texturizing apparatus according to the present invention,
a feeding device, connected to the entrance opening and configured to feed the foodstuff material into the texturizing chamber, and
a mixing device, located upstream of the feeding device and configured to mix ingredients of the foodstuff material.

The texturizing apparatus of the food production device according to the present invention may comprise one or more of the features and/or benefits disclosed herein in relation to the texturizing apparatus according to the present invention, in particular one or more of the features disclosed in claims 1-28.

The mixing device is configured to mix ingredients for the foodstuff material that is to be texturized. The foodstuff material may be a viscoelastic material that may have a dry matter content of more than 20%. An example of such a foodstuff material is a biopolymer mixture for meat substitutes.

The foodstuff material may be composed of one or more dry ingredients, such as dried protein powders, and one or more wet ingredients, such as water and/or vegetable oil. These ingredients are configured to be mixed in the mixing device, to obtain a foodstuff material that may have a paste-like or dough-like appearance.

The mixing device may comprise a kneading mechanism, located downstream of a mixing zone in which mixing of the ingredients is to take place, which kneading device is configured knead the foodstuff material, composed of mixed ingredients, e.g. to obtain a dough-like foodstuff material by increasing strength and elasticity thereof. The kneading may comprise a plurality movable ridges that project into a funnel for the foodstuff material, configured to contact and to knead the foodstuff material in the funnel.

The feeding device is configured to retrieve the foodstuff material from the mixing device and to feed it into the texturizing chamber, i.e. into the upstream chamber segment. The feeding device may comprise a screw conveyor to obtain a pressure build up, so that the foodstuff material can be forced into the texturizing chamber under influence of the pressure difference.

In the food production device according to the present invention, the mixing device and the feeding device may be combined in a single device, configured to mix the ingredients to form the foodstuff material and to feed the foodstuff material into the texturizing chamber.

In an embodiment, the food production device further comprises a hopper, upstream of the mixing device, and configured to receive one or more ingredients for the foodstuff material.

The hopper may be in particular configured to receive one or more dry ingredients for the foodstuff material. The hopper is connected to the mixing device, so that the ingredients from the hopper can be fed into the mixing device. The hopper may be configured to accumulate a batch of ingredients, i.e. dry ingredients, and may be configured to continuously feed the ingredients into the mixing device.

In an embodiment, the food production device further comprises one or more injectors projecting into the mixing device, configured to inject liquid ingredients and/or water into the foodstuff material in the mixing device.

The injectors are configured to feed the liquid ingredients in the mixing device directly, so that the hopper of the food production device may only need to hold dry ingredients. Multiple injectors may be provided along the path of the foodstuff material through the mixing device, in order to feed liquid ingredients to the foodstuff material at certain stages of the mixing process, in particular to feed different types of liquid ingredients, such as water or vegetable oil, to the foodstuff material at different stages of the mixing process.

In an additional or alternative embodiment, the food production device further comprises a preheating device, configured to preheat the foodstuff material in the feeding device and/or the mixing device.

The preheating device is configured to heat the foodstuff material before it enters the upstream chamber segment of the texturizing chamber. As such, a heating device may be omitted in the upstream chamber segment of the texturizing chamber, because the foodstuff material therein may already be heated sufficiently to be subjected to the simple shear flow.

The preheating device is configured to increase the temperature of the foodstuff material in the feeding device and/or the mixing device to a level that is above the ambient temperature, in order to subject the foodstuff material to an elevated temperature during mixing and/or feeding.

The required elevated temperature differs per type of foodstuff material, but may for example being in between 50° C. and 200° C., preferably between 90° C. and 140° C., for a protein-rich biopolymer mixture. At these temperatures, the pressure in the upstream chamber segment may increase above the ambient pressure under the influence of the heating, for example being caused by evaporation of liquids, such as water, or by changes in the protein structure under elevated temperatures, in the foodstuff material.

In a further embodiment of the food production device, the preheating device comprises a preheating fluid circuit that extends through an outer wall of the mixing device and/or the feeding device, configured to guide a flow of preheating fluid.

The preheating device may further comprise a third heat exchanger device, located remote from the feeding device and the mixing device and in fluid connection with the preheating fluid circuit to allow transport of the preheating fluid between the preheating fluid circuit and the third heat exchanger device. The third heat exchanger device may be configured to heat the preheating fluid remote from the mixing device and the feeding device and to pump the heated preheating fluid towards the preheating fluid circuit in the mixing device or feeding device.

According to a third aspect, the present invention provides a method of texturizing a mass of viscoelastic foodstuff material, such as a biopolymer mixture for meat substitutes, the method comprising the steps of:
feeding the foodstuff material in a texturizing chamber,
subjecting the foodstuff material to a simple shear flow by applying shear stresses on the foodstuff material in the upstream chamber segment of the texturizing chamber,
cooling the foodstuff material in the downstream chamber segment of the texturizing chamber, and
discharging the texturized foodstuff material from the texturizing chamber.

The texturizing apparatus used in the method according to the present invention may comprise one or more of the features and/or benefits disclosed herein in relation to the texturizing apparatus according to the present invention, in particular one or more of the features disclosed in claims 1-28 and/or disclosed herein in relation to the food production device according to the present invention, in particular one or more of the features disclosed in claims 29-31.

According to the present invention, the method comprises the texturizing of a viscoelastic material that may have a dry matter content of more than 20%. An example of such a foodstuff material is a biopolymer mixture for meat substitutes. Prior to the texturizing, these foodstuff materials may have a paste-like or dough-like appearance. During the texturizing, fibrous texture is introduced into the foodstuff material and the resulting end product may be a solid.

The texturizing method according to the present invention relies on continuous texturizing of the mass of foodstuff material, which means that foodstuff material can be fed into the texturizing apparatus continuously, for example at a constant rate. Accordingly, the discharge of texturized foodstuff material may also take place continuously, for example at a constant rate as well.

The texturizing is initiated by a relative rotation between an inner member and an outer member, so that the foodstuff material in the upstream chamber segment of the texturizing chamber is subject to an inner surface, i.e. of the outer member, and an outer surface, i.e. of the inner member, that move relative to each in a tangential direction relative to the longitudinal axis. The foodstuff material will become aligned as its contacts the inner surface and the outer surface, because it flows along at least partially with the moving surfaces. This may effect a certain degree of anisotropy in the foodstuff material, which makes the foodstuff material less homogeneous and thereby more analogue to actual whole cut meat products, like beef steak, pork loin or chicken breast.

The velocity profile in the upstream chamber segment of the texturizing chamber, e.g. extending over the shear gap, represents a gradient of the velocity of the foodstuff material relative to the inner surface or the outer surface. According to the present invention, the velocity profile is substantially linear to obtain the simple shear flow, i.e. the Couette flow, in the texturizing chamber and to prevent turbulences.

During texturizing, the foodstuff material travels through the upstream chamber segment of texturizing chamber, i.e. along the longitudinal axis, from a first end of the texturizing chamber to the second end. This axial displacement may be effected by a transportation device, which may be formed by a geometry of the inner member or the outer member

It is important in the texturizing method according to the present invention that the tangential velocity, i.e. as a result of the rotation between the inner member and the outer member, must be relatively large compared to the axial displacement of the foodstuff material. This is required to ensure sufficient texturizing of the foodstuff material and to safeguard that the flow of the foodstuff material remains substantially laminar, preventing it from becoming turbulent, enabling that substantially only simple shear flow or Couette flow takes place.

The ratio between the tangential velocity and the axial displacement of the foodstuff material may be in the range between 2:1 and 400:1. For example, in a texturizing apparatus having an inner member with an outer diameter of 600 mm, a rotational velocity of 15 rpm may amount to a tangential velocity of approximately 0.50 m/s. To obtain the desired properties, an axial displacement, i.e. an axial velocity along the longitudinal axis, of 0.005 m/s may be set to hold the foodstuff material in the texturing chamber for a sufficient time. This may result in a ratio between the tangential velocity and the axial displacement of about 100:1.

During texturizing or prior to texturizing, the foodstuff material may be heated. To be able to discharge the foodstuff material from the texturizing apparatus, the foodstuff material must be cooled, since otherwise the texture therein would change once it is discharged from the texturizing chamber, which resulting texture would be minor compared to the fibrous texture in actual whole cut meat products. Hence, the viscosity of the foodstuff material may decrease significantly upon heating.

The heated and texturized foodstuff material may enter the downstream chamber segment. The foodstuff material thereby passes through the downstream chamber segment in order to be cooled. After having passed the downstream chamber segment, the foodstuff material has been cooled and the foodstuff material can be discharged from the texturizing chamber at a temperature that is low enough to prevent the texture in the foodstuff material from changing, because the viscosity has increased upon cooling.

The prior art relied on passive cooling in the texturizing chamber after the heating and the texturizing had taken place. Alternatively, a cooling fluid was passed through the channels of the heating device, to be able to actively cool the foodstuff material after the heating has taken place.

Due to the continuous nature of the operation of the present texturizing method, it is not possible to alternatingly heat and cool the texturizing chamber, as that would result in insufficient heating and/or cooling and thus in non-continuous operation.

As a solution, the texturizing method according to the present invention comprises the step of cooling the foodstuff material in the downstream chamber segment of the texturizing chamber. As a result thereof, the cooling of the foodstuff material only takes place in the downstream chamber segment, whereas no active cooling takes place in the upstream chamber segment. Hence, the upstream chamber segment is free of any cooling device.

Upon cooling, the viscosity of the foodstuff material is increased. The foodstuff material may thereby undergo a change in rheological properties, for example from being liquid during shearing towards being a semi-solid after cooling or from being semi-solid during shearing towards being a solid after cooling.

Furthermore, the pressure level of the foodstuff material may be lowered upon cooling, for example as the result of thermal contraction of the foodstuff material, or following a change in geometry of the texturizing chamber.

After having passed the downstream chamber segment, the foodstuff material has been cooled and the foodstuff material can be discharged from the texturizing chamber at a temperature that is low enough to prevent the texture in the foodstuff material from changing, because the viscosity has increased upon cooling.

A benefit of the present texturizing method is that the obtained texture in the foodstuff material can improved, compared to the texture that can be provided by means of extrusion. Furthermore, the continuous operation may improve productivity over the existing batchwise texturizing apparatus.

During the step of subjecting the foodstuff material to the simple shear flow, the texturizing apparatus may rotate the inner member and the outer member with respect to each other at a rotational velocity in the range between 1 and 150 rpm. Alternatively or additionally, the texturizing apparatus may rotate the inner member and the outer member with respect to each other at a tangential velocity in the range between 0.05 m/s and 5 m/s.

It was found by the inventors that when the foodstuff materiel were to be subjected to a rotational velocity in the range of 1-150 rpm or a tangential velocity in the range of 0.05-5 m/s, e.g. for a biopolymer mixture for animal protein substitutes, the corresponding shear rate would cause the texture of the foodstuff material to become as best as possible, namely to accurately mimic that of actual whole cut meat products.

The cooling of the foodstuff material in the downstream chamber segment may be carried out continuously, for example at a substantially constant cooling power. The cooling of the foodstuff material by the cooling device in the downstream chamber segment may be effected to cool the foodstuff material to a temperature in the range between 0° C. and 80° C., preferably between 30° C. and 60° C., to allow for discharge from the texturizing chamber.

Alternatively or additionally, the cooling of the foodstuff material in the downstream chamber segment may be carried out to a temperature level that is in between 50° C. and 150° C. lower than the temperature of the foodstuff material in the upstream chamber segment.

In an embodiment, the method further comprises the step of subjecting the foodstuff material to a simple shear flow by applying shear stresses on the foodstuff material in the downstream chamber segment of the texturizing chamber during at least part of the step of cooling.

According to this embodiment, the foodstuff material may be subjected to further shearing once it arrives in the downstream chamber segment where it is cooled. This further shearing may induce more texture in the foodstuff material as compared to when no shearing were to take place during cooling.

However, the rheological properties of the foodstuff material will change upon cooling, i.e. the viscosity will increase upon cooling. At a certain point, the foodstuff material may become too brittle to be subjected to further shearing. At that stage, further shearing in the downstream chamber segment should be avoided.

To prevent the foodstuff material from being subjected to shearing too much in the downstream chamber segment, only part of the second inner wall section and/or second outer wall section may be provided with the corrugated surface.

Nonetheless, prior to this critical point, shearing in the downstream chamber may contribute to different texture properties than the shearing in the upstream chamber. This may be caused by the viscosity of the foodstuff material that is lower in the downstream chamber, i.e. upon cooling, compared to the viscosity of the foodstuff material in the upstream chamber. The combination of shearing at a relatively high viscosity and at a relatively low viscosity may result in an improved texture for the foodstuff material.

In an alternative or additional embodiment of the method, the step of discharging comprises the adjusting of a cross-sectional area of the discharge port on the basis of a measured temperature and/or pressure level in the texturizing chamber.

According to this embodiment, the pressure drop over the discharge port can be adjusted by changing the cross-sectional area of the discharge port. Outside the texturizing chamber, i.e. downstream of the discharge port, the pressure level is at the ambient pressure level. Upstream of the discharge port, i.e. inside the downstream chamber segment of the texturizing chamber, the pressure level may thus vary in dependence of the pressure drop over the discharge port.

Further changing of the pressure level in the texturizing chamber, in particular between the upstream chamber and the downstream chamber, may be effected by a change in shear gap width between the upstream chamber and the downstream chamber and/or by providing a transit passage or intermediate chamber segment in between the upstream chamber and the downstream chamber over which a pressure drop is configured to take place, to obtain a throttling effect over the transit passage.

By changing the pressure level inside the texturizing chamber, shearing parameters of the foodstuff material inside the texturizing chamber may be adjusted to further contribute to obtaining the desired fibrous texture properties.

The adjusting may be carried out by varying an adjustable aperture, located at the discharge port, stepless in a range between fully closed, in which discharge of foodstuff material from the downstream chamber segment can be fully blocked, and fully opened, in which the pressure drop over the discharge port is as low as possible.

The adjusting of the cross-sectional area of the discharge port may be actively controlled by a control unit, so that the pressure level in the texturizing chamber can be changed. This may result in different temperature and/or pressure conditions inside the texturizing chamber, so that these conditions can be optimally adjusted towards the desired conditions. In particular, the control unit may control the adjustable aperture in a feedback-manner, i.e. by repeating steps of measuring with the sensors and of adjusting the adjustable aperture.

In an alternative or additional embodiment, the method further comprises the step of heating the foodstuff material in the upstream chamber segment of the texturizing chamber.

The heating in the upstream chamber segments may be carried out by a heating device that is, as a result of being provided at the upstream chamber segment of the texturizing chamber to heat, provided upstream relative to the cooling device. The heating of the foodstuff material may be carried out without substantially influencing the cooling carried out in the downstream chamber segment.

The heating is configured to effect an increase in temperature of the foodstuff material in the upstream chamber segment to a level that is above the ambient temperature, in order to subject the foodstuff material to an elevated temperature.

The required elevated temperature differs per type of foodstuff material, but may for example being in between 50° C. and 200° C., for example between 90° C. and 140° C., for a protein-rich biopolymer mixture. At these temperatures, the pressure in the upstream chamber segment may increase above the ambient pressure under the influence of the heating, for example being caused by evaporation of liquids, such as water, or by changes in the protein structure under elevated temperatures, in the foodstuff material.

At the elevated temperature, the viscosity of the foodstuff material is lowered and the biopolymers are mobilized to effect alignment of the mass. The foodstuff material may for example change from being a semi-solid at introduction in the texturizing chamber towards being a liquid after heating or from being solid at introduction towards being a semi-solid after heating.

Furthermore, the pressure level of the foodstuff material may increase upon heating, for example as the result of thermal expansion of the foodstuff material, or following a change in geometry of the texturizing chamber.

The aligned mass results in a fibrous texture of the foodstuff material, being aligned in the direction of the relative rotation between the inner member and the outer member, e.g. becoming aligned in the tangential direction.

In a further embodiment, the heating of the foodstuff material may be carried out by means of a heating fluid circuit that extends through one or more wall sections of the texturizing chamber, through which a flow of heating fluid is guided.

The heating device may further comprise a heat exchanger device, located remote from the texturizing chamber and in fluid connection with the heating fluid circuit to allow transport of the heating fluid between the heating fluid circuit and the heat exchanger device. The heat exchanger device may be configured to heat the heating fluid remote from the texturizing chamber and to pump the heated heating fluid towards the heating fluid circuit in the first outer wall section and/or the first inner wall section, where the heat is transferred onto the foodstuff material in the upstream chamber segment. The heating fluid is thereby cooled and is transported back to the heat exchanger device, which is configured to re-heat the heating fluid.

The heating fluid may be pressurized steam, having a temperature of more than 100° C., i.e. on entry in the heating fluid circuit. The use of steam may be beneficial for heating the foodstuff material, as it may undergo a phase change when being cooled. Cooling the steam from a vapor phase to a liquid phase may release the heat of condensation from the steam, which may be contribute in heating the foodstuff material.

In an embodiment of the method, the step of cooling the foodstuff material comprises subjecting the foodstuff material to a phase transition from a viscous state, e.g. a liquid or fluid state, into a solid state. The foodstuff material may thereby solidify during cooling as it enters the solid state. The induced texture may thereby be fixed, so that the eventual products can maintain the desired texture.

In an embodiment of the method, during the step of cooling, the foodstuff material is cooled from a temperature in the range between 50° C.-200° C., preferably between 90° C. and 140° C., to a temperature in the range between 0° C.-80° C., preferably between 30° C. and 60° C. It was found by the applicant that heating temperatures and cooling temperatures in these respective range may offer desirable texture properties for the foodstuff material, especially for biopolymer mixtures for animal protein substitutes.

In an embodiment of the method, the texturizing chamber is defined between an outer member, which defines an interior, and an inner member, which is arranged inside the interior of the outer member, wherein the outer member is held stationary and wherein the inner member is rotated with respect to the outer member about a longitudinal axis to subject the foodstuff material in the texturizing chamber to the simple shear flow.

According to this embodiment, the outer member is held stationary, for example in a frame assembly of the texturizing apparatus. The texturizing apparatus may further comprise a motor, such as an electric motor, which may be mounted on the frame assembly and which is configured to rotate the inner member.

The stationary outer member may be beneficial in case the heating device, i.e. the heating fluid circuit, and/or cooling device, i.e. the cooling fluid circuit, were to be included in the outer member. In this way, all fluid connections can be held stationary as well, reducing complexity of the apparatus. Furthermore, the inner surface of the outer member has a larger surface area than the outer surface of the inner member, as a result of the gap between the inner member and the outer member. This may provide a further benefit that the heat-conductive area can be larger when the heating device and/or the cooling device were to be provided in the outer member, thus offering an improved heat exchange.

### BRIEF DESCRIPTION OF DRAWINGS

Further characteristics of the invention will be explained below, with reference to embodiments, which are displayed in the appended drawings, in which:

FIG. 1 schematically depicts an embodiment of the food production device according to the present invention, comprising an embodiment of the texturizing apparatus according to the present invention.

FIG. 2 schematically depicts an inner member of the texturizing apparatus of FIG. 1.

FIG. 3 shows an enlargement of the highlighted part E of FIG. 2.

FIG. 4 schematically depicts a cross-sectional side view of the texturizing apparatus of FIG. 1.

FIG. 5 shows an enlargement of the highlighted part B of FIG. 4.

FIG. 6 schematically depicts a cross-sectional view perpendicular to the longitudinal axis of the part of the texturizing apparatus shown in FIG. 5.

FIG. 7 schematically depicts the inner member and the outer member of an embodiment of the texturizing apparatus according to the present invention.

Throughout the figures, the same reference numerals are used to refer to corresponding components or to components that have a corresponding function.

### DETAILED DESCRIPTION OF EMBODIMENTS

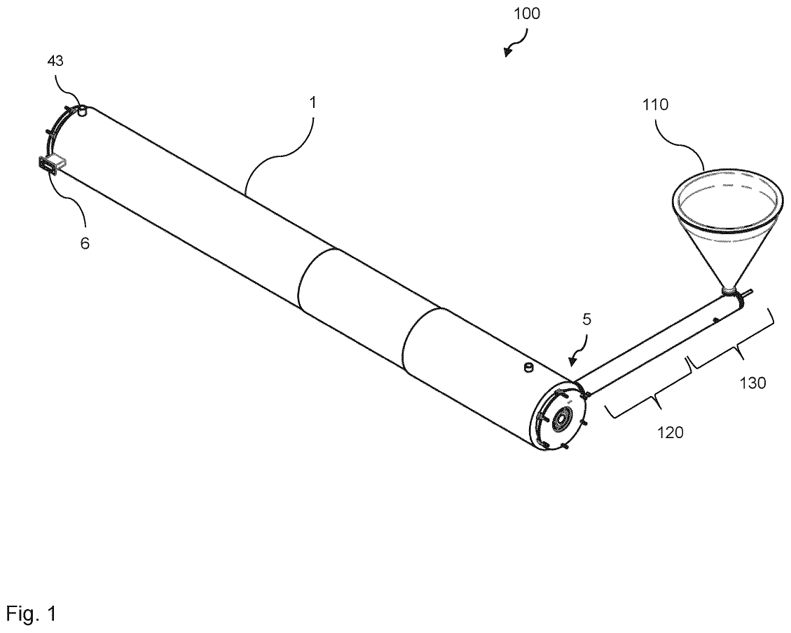

FIG. 1 schematically depicts an embodiment of the food production device according to the present invention, to which is referred with reference numeral 100. The food production device 100 comprises an embodiment of the texturizing apparatus 1 according to the present invention and further comprises a hopper 110, a feeding device 120 and a mixing device 130.

The food production device 100 is configured to form foodstuff products from a mass of viscoelastic foodstuff material F, such as a biopolymer mixture for meat substitutes. The device 100 thereto comprises the texturizing apparatus 1, which is configured to texturize the mass of viscoelastic foodstuff material by subjecting the mass to a simple shear flow in between a cylindrical outer member 10 and a cylindrical inner member 20.

The hopper 110 of the device 100 is located upstream of the mixing device 130 and is configured to receive one or more dry ingredients for the foodstuff material. The hopper 110 can accumulate a batch of dry ingredients and is configured to continuously feed the ingredients into the mixing device 130, to which it is connected to feed the dry ingredients from the hopper 110 into the mixing device 130.

The mixing device 130 is configured to mix the ingredients for the foodstuff material. The foodstuff material is composed of one or more dry ingredients, such as dried protein powders, and one or more wet ingredients, such as water and/or vegetable oil. These ingredients are configured to be mixed in the mixing device 130, to obtain a foodstuff material that has a paste-like or dough-like appearance.

The food production device 100 comprises multiple injectors projecting into the mixing device 130, not visible in the figures, which are configured to inject the liquid ingredients and the water into the foodstuff material in the mixing device 130 directly, so that the hopper 110 only needs to hold dry ingredients.

The mixing device 130 comprises a kneading mechanism, not visible in the figures, which is located downstream of a mixing zone in which mixing of the ingredients is to take place. The kneading device is configured knead the foodstuff material, to obtain a dough-like foodstuff material by increasing strength and elasticity thereof.

The feeding device 120 is configured to retrieve the foodstuff material from the mixing device 130 and to feed it into a texturizing chamber 2 of the texturizing apparatus 1, i.e. into an upstream chamber segment 3 thereof. The feeding device 120 comprises a screw conveyor to obtain a pressure build up, so that the foodstuff material can be forced into the texturizing chamber 2 under influence of the pressure difference.

It is shown in FIG. 1 that the mixing device 130 and the feeding device 120 are combined in a single device, configured to mix the ingredients to form the foodstuff material and to feed the foodstuff material into the texturizing chamber 2.

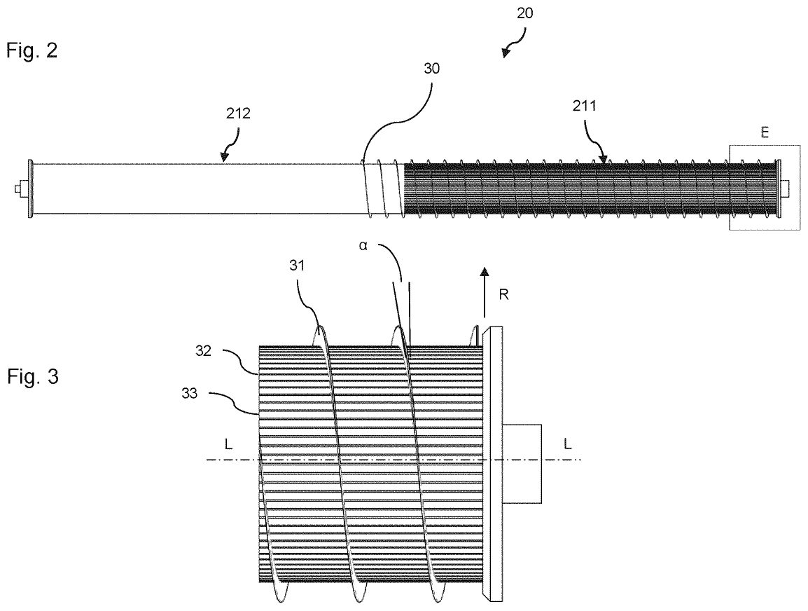

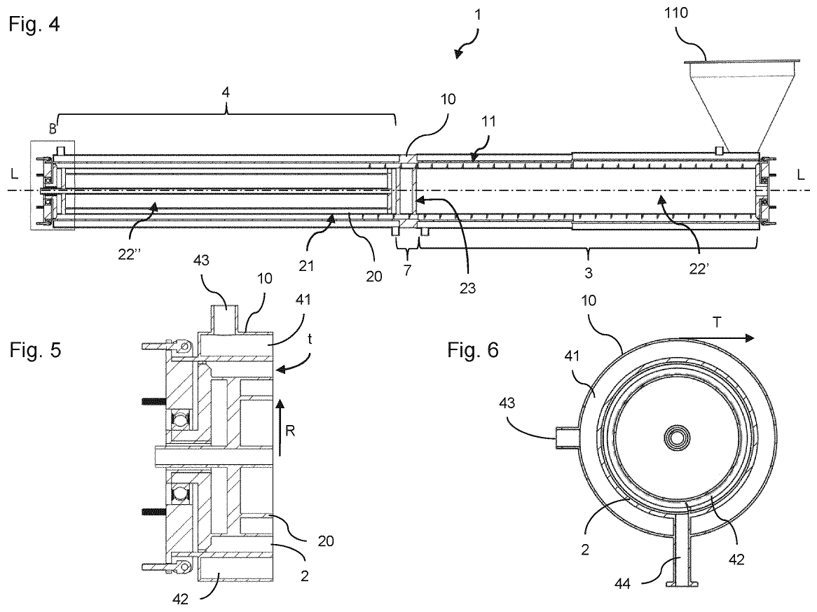

An embodiment of the texturizing apparatus 1 according to the present invention is shown in cross-sectional view in FIG. 4 and comprises an outer member 10 and an inner member 20, shown in more detail in FIG. 2. The members 10, 20 have a cylindrical shape and are provided concentrically about a common longitudinal axis L. The inner member 20 is configured to be rotated relative to the outer member 10 about the longitudinal axis L.

The inner member 20 is located inside the outer member 10, so that the inner surface 21 of the outer member 20 faces the outer surface 21 of the inner member 20 and that a texturizing chamber 2 is present in between them. A shear gap t of the texturizing chamber 2, is defined as the spacing in a radial direction R between the inner member 20 and the outer member 10. The shear gap t varies in the range between 10 mm and 50 mm.

The inner diameter 11 of the outer member 10 varies over the length of the texturizing chamber 2, i.e. the length along the longitudinal axis L, but is in the range between 500 mm and 600 mm. The outer diameter 21 of the inner member 20 also varies over the length of the texturizing chamber 2 and is in the range between 400 mm and 550 mm.

The texturizing of the foodstuff material is initiated by a relative rotation between the inner member 20 and the outer member 10, so that the foodstuff material in the texturizing chamber 2 is subject to an inner surface 11 of the outer member 10 and an outer surface 21 of the inner member 20 that move relative to each in a tangential direction T relative to the longitudinal axis L. The foodstuff material will become aligned as its contacts the inner surface 21 and the outer surface 11, because it flows along at least partially with the moving surfaces. The velocity profile in the texturizing chamber 2, extending over the shear gap t, represents a gradient of the velocity of the foodstuff material relative to the inner surface 21 or the outer surface 11. According to the present embodiment, the velocity profile is substantially linear to obtain the simple shear flow, i.e. the Couette flow, in the texturizing chamber 2 and to prevent turbulences.

During texturizing, the foodstuff material travels through the texturizing chamber 2 along the longitudinal axis L, from the first end of the texturizing chamber 2, shown on the right in FIG. 4, to the second end, shown on the left. In particular, the texturizing apparatus 1 is configured to transport the foodstuff material from an entrance opening 5, where the texturizing apparatus 1 is connected to the feeding device 120, to a discharge port 6., located at an opposite end of the texturizing chamber 2, seen along the longitudinal axis L. The foodstuff material thereby passes through substantially the entire texturizing chamber 2 on its path from the entrance opening 5 to the discharge port 6.

According to the present embodiment, the discharge port 6 is positioned radially relative to the axial direction L, which means that the foodstuff material is configured to be discharged in a discharge direction aligned in between the radial direction R and the tangential direction T.

The discharge port 6 comprises an adjustable aperture, not visible in the figures, which is configured to adjust a cross-sectional area of the discharge port 6. By changing the cross-sectional area of the discharge port 6, the pressure drop over the discharge port 6 can be adjusted. Outside the texturizing apparatus 1, i.e. downstream of the discharge port 6, the pressure level is at the ambient pressure level. Upstream of the discharge port 6, i.e. inside the downstream chamber segment 4 of the texturizing chamber 2, the pressure level may be varied in dependence of the pressure drop over the discharge port 6.

The texturizing chamber 2 comprises an upstream chamber segment 3 and a downstream chamber segment 4, i.e. being subdivided in an upstream chamber segment 3, which is located at entrance opening 5, and a downstream chamber segment 4, which is located at the discharge port 6.

The upstream chamber segment 3 and the downstream chamber segment 4 are different parts of a single texturizing chamber 2, that are not physically separated from each other, but are instead separated by an intermediate chamber segment 7 in between them.

The texturizing apparatus 1 comprises a cooling device 40, provided at the downstream chamber segment 4 of the texturizing chamber 2 and configured to only cool the downstream chamber segment 4 of the texturizing chamber 2. As a result thereof, the cooling of the foodstuff material only takes place in the downstream chamber segment 4, whereas no active cooling is configured to take place in the upstream chamber segment 3 and in the intermediate chamber segment 7.

The texturizing apparatus 1 further comprises a heating device 50, provided at the upstream chamber segment 3 of the texturizing chamber 2 and configured to only heat the upstream chamber segment 3 of the texturizing chamber 2 to heat, at least during use, the foodstuff material arranged therein. The heating device 50 is provided upstream relative to the cooling device 40, so that it can heat the foodstuff material without substantially influencing the cooling carried out by the cooling device 40 in the downstream chamber segment 4. The heating device 50 is thereby configured to increase the temperature of the upstream chamber segment 3 to a level that is above the ambient temperature, in order to subject the foodstuff material to an elevated temperature during use of the apparatus 1.

The intermediate chamber segment 7 is free of heating devices and cooling devices, so that the temperature of the foodstuff material remains relatively constant as it passes through the intermediate chamber segment 7. It is envisaged that passive cooling of the foodstuff material, i.e. from the intermediate chamber segment 7 of the texturizing chamber 2 to the ambient, may be unavoidable within the context of this embodiment.

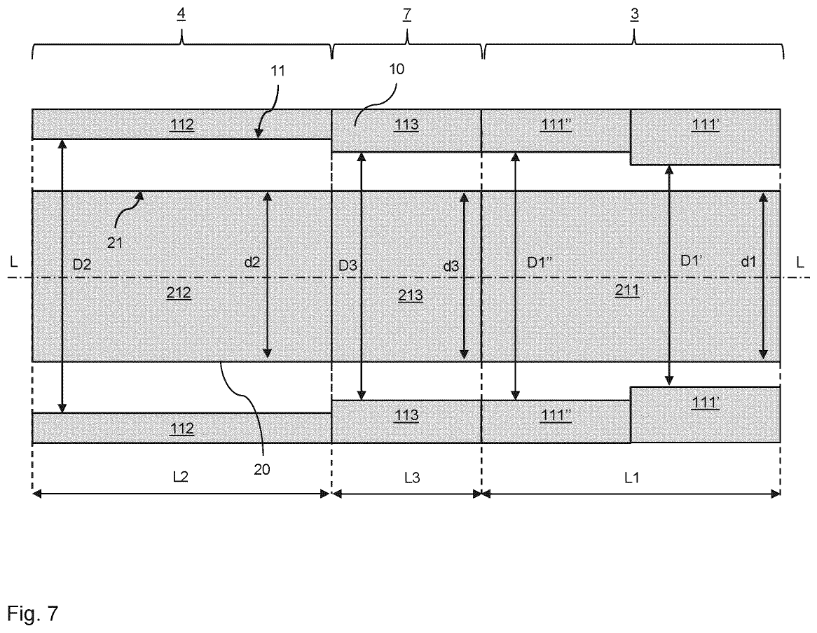

The upstream chamber segment 3 is defined between a first outer wall section 111 of the outer member 10 and a first inner wall section 211 of the inner member 20. Seen in FIG. 4, the first outer wall section 111 and the first inner wall section 211 are visible on the right. The downstream chamber segment 4 is defined between a second outer wall section 112 of the outer member 10 and a second inner wall section 212 of the inner member 20. Seen in FIG. 4, the second outer wall section 112 and the second inner wall section 212 are visible on the left. FIG. 7 schematically depicts the inner member 20 and the outer member 10 of a texturizing apparatus 1, displaying all wall sections thereof.

In between the first outer wall section 111 and the second outer wall section 112, an intermediate outer wall section 113 of the outer member 10 is defined and in between the first inner wall section 211 and the second inner wall section 212, an intermediate inner wall section 213 of the inner member 20 is defined. The intermediate chamber segment 7 is thereby defined in between the intermediate outer wall section 113 and the intermediate inner wall section 213, i.e. at a transition second of the texturizing chamber 2.

The outer member 10 is thus subdivided in a first outer wall section 111, an intermediate outer wall section 113, located downstream of the first outer wall section 111 and a second outer wall section 112, located downstream of the intermediate outer wall section 113.

Similarly, the inner member 20 is subdivided in a first inner wall section 211, an intermediate inner wall section 213, located downstream of the first inner wall section 211 and a second inner wall section 212, located downstream of the intermediate inner wall section 213.

The upstream chamber segment 3 has a first length L1 along the longitudinal axis L, the downstream chamber segment 4 has a second length L2 along the longitudinal axis L and the intermediate chamber segment 5 has a third length L3 along the longitudinal axis L. In the present embodiment, shown in FIG. 7, the first length L1 is equal to the second length L2 and the third length L3 is equal to half the first length L1 and the second length L2. As such, the length of the upstream chamber segment 3 along the longitudinal axis L is equal to the length of the downstream chamber segment 4. Alternatively, however, the first length may be larger than the second length, or vice versa.

The first outer wall section 111 has a first inner diameter D1 and the first inner wall section 211 has a first outer diameter d1. Furthermore, the first outer wall section 111 is subdivided in two different parts, i.e. a first part 111′ and a second part 111″. The first part 111′ has a diameter D1′ that is smaller than the diameter D″ of the second part 111″. The first inner wall section 211 is not subdivided in multiple parts and has a constant first outer diameter d1. Accordingly, the shear gap in the upstream chamber segment 3 is relatively narrow at the first part 111′ of the first outer wall section and relatively wide at the second part 111″of the second outer wall section.

The second outer wall section 112 has a second inner diameter D2, different from the first inner diameter D1, and the second inner wall section 212 has a second outer diameter d2, equal to the first outer diameter d1. The inner diameters of the outer member 10 are thus different between both wall sections 111, 112 and, accordingly, the shear gap is different between the upstream chamber segment 3 and the downstream chamber segment 4.

The intermediate outer wall section 113 has a third inner diameter D3, equal to the diameter D1″ of the second part 111″ of the first outer wall section, and the intermediate inner wall section 213 has a third outer diameter d3, equal to the first outer diameter d1. The inner diameters of the outer member 10 are thus the same and, accordingly, the shear gap is the same in the second part of the upstream chamber segment 3 and the intermediate chamber segment 7.

It is shown in FIG. 7 that the outer wall sections, e.g. the first part 111′ of the first outer wall section, the second part 111″ of the first outer wall section, the second outer wall section 112 and the intermediate outer wall section 113, are distinct modules that are attached to each other to form, in combination, the outer member 10. Correspondingly, the inner member 20 is composed of distinct modules for the first inner wall section 211, the second inner wall section 212 and the intermediate inner wall section 213. By varying the number of modules, the overall length of the texturizing chamber 2 can be changed accordingly. This implies that the residence time of the foodstuff material in the texturizing chamber 2 can be changed.

It is shown best in the cross-sectional view of FIG. 4 that the inner member 20 is substantially hollow, defining an inner member interior 22. The hollow inner member interior 22 is closed-off substantially from the environment of the texturizing apparatus 1, in order to contribute to the heating of the foodstuff material in the upstream chamber segment 3 and to the cooling of the foodstuff material in the downstream chamber segment 4.

The inner member 20 further comprises a separation wall 23 at the intermediate inner wall section 213, i.e. in between the first inner wall section 211 and the second inner wall section 212, and is aligned substantially perpendicular to the longitudinal axis L. The separation wall 23 is configured to subdivide the inner member interior 22 in a first inner member interior 22′ and a second inner member interior 22″. The separation wall 23 is configured to form a thermal insulation between the first inner member interior 22′ and the second inner member interior 22″, to prevent heating in the first inner member interior 22′ from influencing cooling in the second inner member interior 22″, or vice versa.

The texturizing apparatus 1 comprises a transportation device, configured to transport the foodstuff material through the texturizing chamber 2, which is embodied as an auger 30 extending spirally over part of the outer surface 21 of the inner member 20. The auger 30 defines an unobstructed spiral path through the texturizing chamber 2 and is, upon rotation of the inner member 20 inside the outer member 10, configured to axially displace the foodstuff material through the texturizing chamber 2, i.e. along the longitudinal axis L, from right to left in FIG. 4.

The unobstructed spiral path of the auger 30 implies that the foodstuff material will not encounter any ridges or disturbances on the auger 30 as it is displaced through the texturizing chamber 2. As a result of the unobstructed spiral path, the foodstuff material remains in contact with the outer surface 21 of the inner member 20 and with the inner surface 11 of the outer member 10 during most of its path through the texturizing chamber 2.

The present auger 30 comprises a single spiral path, as is shown in FIG. 3, having a single lead 31 over the circumference of the inner member 20. As such, the auger 30 has a relatively low pitch. As a result, it is achieved that the shearing velocity in the tangential direction T is significantly larger than the axial displacement along the longitudinal axis L. In the present embodiment, the auger 30 has a pitch angle a, i.e. the angle between the lead 31 and the tangential direction T, of about 5°.

The auger 30 extends over the entire first inner wall section 211 of the inner member 20 and over the entire intermediate inner wall section 213 of the inner member 20, so that it extends through the entire upstream chamber segment 3 and through the entire intermediate chamber segment 7. The auger 30 furthermore extends over a part of the second inner wall section 212, so that it extends only through part of the downstream chamber segment 4. A remining part of the downstream chamber segment 4 is substantially free of an auger, so that the foodstuff material will not come in contact with an auger after it was cooled down to a certain extent in the downstream chamber segment 4 by the cooling device 40, thereby preventing disturbance of the texture that has been created.

The height of the auger 30, i.e. in the radial direction R relative to the longitudinal axis L, corresponds to only part of the radial spacing between the inner member 20 and the outer member 10. As such, the auger 30 spans only part of the shear gap, so that it only acts directly on parts of the foodstuff material located adjacent the inner member 20. Other parts of the foodstuff material, i.e. parts of the foodstuff material located away from the inner member 20, but for example located adjacent the outer member 10, will only be forced in the axial direction indirectly.

It is best shown in FIGS. 2 and 3 that part of the outer surface 21 of the inner member 20 comprises a corrugated surface, embodied as lengthwise ridges 32 and grooves 33 on the circumference of the inner member 20, which are aligned parallel to the longitudinal axis L. The ridges 2 and grooves 33 are configured to increase contact between the respective outer surface 21 of the inner member 20 and the foodstuff material during use of the apparatus 1.

The grooves 32 and ridges 33 are provided on the entire first inner wall section 211 of the inner member 20 and on the entire intermediate inner wall section 213 of the inner member 20, so that they extend through the entire upstream chamber segment 3 and through the entire intermediate chamber segment 7. The grooves 32 and ridges 33 are not provided on the second inner wall section 212, so the downstream chamber segment 4 is substantially free of corrugations. As such, foodstuff material will not come in contact with corrugations after it was cooled down in the downstream chamber segment 4 by the cooling device 40, thereby preventing disturbance of the texture that has been created.

In the present embodiment, as is shown in FIG. 4, the heating device 50 is provided in the first outer wall section 111 and in the hollow interior 22 of the inner member 20. The heating device 50 thereto comprises a heating fluid circuit, configured to guide a flow of heating fluid, which circuit extends through the first outer wall section 111 and which projects into the hollow interior 22 of the inner member 20.

The first outer wall section 111 is a hollow wall section to define the heating fluid circuit, so that heat from the heating fluid is conducted to the first outer wall section 111 and, in turn, be transferred onto the foodstuff material that is in contact with the first outer wall section 111.

The heating fluid circuit projects into the hollow interior 22 of the inner member 20 and is configured to discharge heating fluid, such as steam, into the hollow interior 22 of the inner member 20. The heat from the steam is thereby conducted to the first inner wall section 211 and is, in turn, transferred onto the foodstuff material that is in contact with the first inner wall section 211.

The heating device 50 further comprises a heat exchanger device, n not visible in the figures, which is located remote from the texturizing chamber 1 and which is in fluid connection with the heating fluid circuit to allow transport of the heating fluid between the heating fluid circuit and the heat exchanger device.

It is shown in FIGS. 4-6 that the cooling device 40 is provided in the second outer wall section 112 and in the second inner wall section 212. The cooling device 40 thereto comprises a cooling fluid circuit that extends through the second outer wall section 112 and through the second inner wall section 212, configured to guide a flow of cooling fluid.

The second outer wall section 112 is hollow to define an outer cooling fluid passage 41, connected to an outer cooling fluid inlet 43, and the second inner wall section 212 is hollow to define an inner cooling fluid passage 42, connected to an inner cooling fluid inlet 44. As such, heat from the foodstuff material in the downstream chamber segment 4 can be withdrawn into the cooling fluid in the cooling fluid circuit, i.e. via the respective wall section with which the foodstuff material is in contact, e.g. into the outer cooling fluid passage 41 via the second outer wall section 112 and into the inner cooling fluid passage 42 via the second inner wall section 212. The cooling fluid circuit is thus both located in the stationary outer member 10 and in the rotary inner member 20, comprising a rotary joint to allow the cooling fluid to flow into the rotary member 20.

The cooling device 40 further comprises a second heat exchanger device, not visible in the figures either, which is located remote from the texturizing chamber 1 and which is in fluid connection with the cooling fluid circuit, e.g. with the outer cooling fluid inlet 43 and the inner cooling fluid inlet 44, to allow transport of the cooling fluid between the cooling fluid circuit and the second heat exchanger device.

1-38. (canceled)

39. A texturizing apparatus, configured to texturize a mass of viscoelastic foodstuff, the apparatus comprising:
an outer member, which defines an interior, extending along a longitudinal axis between a first end and a second end and having a circular cross-section in a plane perpendicular to the longitudinal axis,
an inner member, which is arranged inside the interior, extending parallel to the longitudinal axis between the first end and the second end and having a circular cross-section in a plane perpendicular to the longitudinal axis,
wherein the outer member has an inner surface in the interior that faces an outer surface of the inner member to define a through annular texturizing chamber in between the inner member and the outer member, extending between the first end and the second end, and
wherein the outer member and the inner member are configured to rotate with respect to each other about the longitudinal axis to subject the foodstuff material in the texturizing chamber to a simple shear flow,
wherein a shear gap of the texturizing chamber is defined as the radial spacing between the inner member and the outer member, wherein the shear gap is in the range between 10 mm and 50 mm,
wherein the texturizing chamber comprises an upstream chamber segment and a downstream chamber segment, and
wherein the texturizing apparatus further comprises:
a cooling device, provided at the downstream chamber segment of the texturizing chamber and configured to only cool the downstream chamber segment of the texturizing chamber.

40. The texturizing apparatus according to claim 39, further comprising a heating device, provided at the upstream chamber segment of the texturizing chamber and configured to only heat the upstream chamber segment of the texturizing chamber.

41. The texturizing apparatus according to claim 39, wherein the upstream chamber segment is free of any cooling device.

42. The texturizing apparatus according to claim 39, wherein the inner member is substantially hollow, defining an inner member interior.

43. The texturizing apparatus according to claim 39, wherein the outer member comprises:
a first outer wall section, extending between the first end and a transition section, located in between the first end and the second end, and
a second outer wall section, extending between the transition section and the second end,
wherein the upstream chamber segment is defined between the first outer wall section and the inner member, and
wherein the downstream chamber segment is defined between the second outer wall section and the inner member, wherein the first outer wall section has a first inner diameter and wherein the second outer wall section has a second inner diameter.

44. The texturizing apparatus according to claim 43, wherein the inner member comprises:
a first inner wall section, facing the first outer wall section to define the upstream chamber segment, and
a second inner wall section, facing the second outer wall section to define the downstream chamber segment,
wherein the first inner wall section has a first outer diameter and wherein the second inner wall section has a second outer diameter, and
wherein the inner member for example comprises a separation wall in between the first inner wall section and the second inner wall section, aligned substantially perpendicular to the longitudinal axis and configured to subdivide the inner member interior in a first inner member interior and a second inner member interior.

45. The texturizing chamber according to claim 43, wherein the heating device is provided in the first outer wall section and in the first inner wall section, and
wherein the cooling device is provided in the second outer wall section and in the second inner wall section.

46. The texturizing apparatus according to claim 39, further comprising:
an entrance opening, located at the first end, in direct fluid contact with the upstream chamber segment and configured to provide access to the texturizing chamber for the mass of foodstuff material, and
a discharge port, located at the second end, in direct fluid contact with the downstream chamber segment and configured to allow discharge of texturized foodstuff material from the texturizing chamber.

47. The texturizing apparatus according to claim 39, wherein the outer member is configured to be held stationary, and wherein the inner member is configured to be rotated with respect to the outer member.

48. The texturizing apparatus according to claim 47, wherein the transportation device comprises an auger extending spirally over at least part of an outer surface of the inner member, the auger defining an unobstructed spiral path through the texturizing chamber.

49. The texturizing apparatus according to claim 47, wherein the transportation device is configured to axially displace the foodstuff material through the texturizing chamber under influence of a pressure difference between the first end and the second end.

50. The texturizing apparatus according to claim 39, wherein the discharge port comprises an adjustable aperture, configured to adjust a cross-sectional area of the discharge port.

51. The texturizing apparatus according to claim 50, further comprising:
one or more temperature sensors located in the texturizing chamber and configured to emit a sensor signal representative for the temperature in the texturizing chamber:
a control unit, configured to control the adjustable aperture on the basis of the measured temperature and/or pressure level in the texturizing chamber.

52. The texturizing apparatus according to claim 51, wherein the control unit is further configured to control the heating device and the cooling device on the basis of the measured temperature in the texturizing chamber.

53. The texturizing apparatus according to claim 39, wherein at least part of the inner surface of the outer member and at least part of the outer surface of the inner member comprises a corrugated surface.

54. A food production device, configured to form foodstuff products from a mass of viscoelastic foodstuff material,
the food production device comprising,
the texturizing apparatus according to claim 39,
a feeding device, connected to the entrance opening and configured to feed the foodstuff material into the texturizing chamber, and
a mixing device, located upstream of the feeding device and configured to mix ingredients of the foodstuff material,
further comprising optionally one or more injectors projecting into the mixing device, configured to inject liquid ingredients and water into the foodstuff material in the mixing device.

55. A method of texturizing a mass of viscoelastic foodstuff material, comprising the steps of:
feeding the foodstuff material in a texturizing chamber,
subjecting the foodstuff material to a simple shear flow by applying shear stresses on the foodstuff material in the upstream chamber segment of the texturizing chamber,
cooling the foodstuff material in the downstream chamber segment of the texturizing chamber to increase the viscosity of the foodstuff material, and
discharging the texturized foodstuff material from the texturizing chamber.

56. The method according to claim 55, further comprising the step of subjecting the foodstuff material to a simple shear flow by applying shear stresses on the foodstuff material in the downstream chamber segment of the texturizing chamber during at least part of the step of cooling, and
further comprising the step of heating the foodstuff material in the upstream chamber segment of the texturizing chamber to decrease the viscosity of the foodstuff material.

57. The method according to claim 55, wherein the step of discharging comprises the adjusting of a cross-sectional area of the discharge port on the basis of a measured temperature and pressure level in the texturizing chamber.

58. The method according to claim 55, wherein the texturizing chamber is defined between an outer member, which defines an interior, and an inner member, which is arranged inside the interior of the outer member,
wherein the outer member is held stationary and wherein the inner member is rotated with respect to the outer member about a longitudinal axis to subject the foodstuff material in the texturizing chamber to the simple shear flow.
